(19) United States
(12) Patent Application Publication
(10) Pub. No.: US 2017/0044695 A1
(43) Pub. Date: Feb. 16, 2017

(54) SYSTEMS AND ARTICLES OF MANUFACTURE EMPLOYING LONG-TERM COOLING MATERIAL AND PROCESSES TO GENERATE THE LONG-TERM COOLING MATERIAL AND ARTICLES OF MANUFACTURE

(71) Applicants: Tosha Hays, Atlanta, GA (US); Mary-Cathryn Kolb, Atlanta, GA (US)

(72) Inventors: Tosha Hays, Atlanta, GA (US); Mary-Cathryn Kolb, Atlanta, GA (US)

(21) Appl. No.: 14/924,002

(22) Filed: Oct. 27, 2015

Related U.S. Application Data
(60) Provisional application No. 62/069,238, filed on Oct. 27, 2014.

(51) Int. Cl. D02J 1/00; B32B 1/00; D04B 1/24; D06M 11/83; D04B 1/14; D04B 1/22; B32B 5/26; B32B 5/02

(52) U.S. Cl. CPC D02J 1/00; B32B 5/26; B32B 1/00; B32B 5/026; D06M 11/83; D04B 1/14; D04B 1/225; D04B 1/24; B32B 2307/302; B32B 2437/00; D06M 2101/34

(57) ABSTRACT

A long-term cooling material is provided. The long-term cooling material includes: a yarn having a defined denier of less than or equal to approximately 70 denier and a defined yarn count; and a cooling mineral core disposed on the yarn and comprising nanosilver, wherein the cooling material is a material knit on a 28 gauge or greater knitting machine. In some embodiments, the yarn count can be greater than or equal to approximately 36 rows per inch. The yarn can include Nylon 6. An article of manufacture is provided. The article can include a non-cooling material disposed to be positioned over two or more portions of the body; and a cooling material disposed to be positioned on the non-cooling material at selected locations indicative of areas of the body prone to overheating.

### CROSS-REFERENCE TO RELATED APPLICATIONS

This application claims priority to and the benefit of U.S. provisional patent application No. 62/069,238, filed Oct. 27, 2014, and titled “Systems, Articles of Manufacture and Methods Employing Long-Term Cooling Material,” the entirety of which is incorporated by reference herein.

### TECHNICAL FIELD

The subject disclosure relates generally to cooling material, and specifically to systems and articles of manufacture employing long-term cooling material and processes to generate the long-term cooling material and/or articles of manufacture.

### BACKGROUND

Humans suffer from overheating or hot flashes from menopause, exercise, inside/outside temperatures and/or activities. Unfortunately, existing cooling material typically employs a cooling finish on the material that is only temporary and washes away after repeated wear, uses fabrics that absorb water for temporary cooling until the water evaporates, cool by facilitating air flow to the body via insertion of a mesh pattern in the material, claim cooling by wicking and/or cool by yarns such as polyester or other yarn which provide quick dry or easier air flow throughout the fabric in order to feel a cooling sensation. Accordingly, systems, articles of manufacture and processes that facilitate long-term cooling that can reduce skin temperature are desired.

### BRIEF DESCRIPTION OF THE DRAWINGS

FIG. 1 illustrates a flow diagram of a process of manufacture of a first embodiment of a long-term cooling material, Nylon 6, according to one or more embodiments described herein.

FIG. 2 illustrates a plan view of a second embodiment of a long-term cooling material including nanosilver according to one or more embodiments described herein.

FIG. 3 illustrates a schematic diagram of a twin extruder configured to manufacture the second embodiment of the long-term cooling material including nanosilver according to one or more embodiments described herein.

FIG. 4 illustrates a schematic diagram of an extruder spinneret according to one or more embodiments described herein.

FIG. 5 illustrates a flow diagram of a process of yarn drawing the first or second embodiment of the long-term cooling material according to one or more embodiments described herein.

FIG. 6 is a graph illustrating the relationship between fiber tenacity and yarn tenacity according to one or more embodiments described herein.

FIG. 7 illustrates examples of cross-sections for various embodiments of long-term cooling material according to one or more embodiments described herein.

FIGS. 8 and 9 illustrate schematic diagrams of plan views of low and high density fabrics described herein according to one or more embodiments described herein.

FIG. 10 illustrates plan and perspective views of bandanas including and/or composed of long-term cooling material in accordance with one or more embodiments described herein.

FIG. 11 illustrates plan and perspective views of wraps, pashminas or scarfs including and/or composed of long-term cooling material in accordance with one or more embodiments described herein.

FIGS. 12 and 13 illustrate example plan and perspective views of wraps or scarfs with sleeves including and/or composed of long-term cooling material in accordance with one or more embodiments described herein.

FIGS. 14-18 illustrate perspective views of example apparel including and/or composed of long-term cooling material in accordance with one or more embodiments described herein.

FIG. 19 illustrates perspective views of examples of a cowl neck blouse and a multi-layer blouse, each composed of strategically placed long-term cooling material and non-cooling material in accordance with one or more embodiments described herein.

FIG. 20 illustrates perspective, side and top views of examples of a jacket, shoes, boots and a shirt, each composed of strategically placed long-term cooling material and non-cooling material in accordance with one or more embodiments described herein.

FIG. 21 illustrates perspective views of an examples of a jacket having a lapel including and/or composed of strategically placed long-term cooling material and non-cooling material in accordance with one or more embodiments described herein.

FIG. 22 illustrates a perspective view of an example of a brassiere having an inner lining including and/or composed of long-term cooling material and cooling gore provided at the mid-section of the brassiere in accordance with one or more embodiments described herein.

FIG. 23 illustrates a perspective view of an example of an undergarment having a pocket for cooling gel or removable moisture pads, anti-microbial and/or long-term cooling material and non-cooling material strategically positioned within the undergarment in accordance with one or more embodiments described herein.

FIG. 24 illustrates a perspective view of an example of a duvet cover having a top layer composed of non-cooling material and a bottom layer composed of long-term cooling material in accordance with one or more embodiments described herein.

FIGS. 25-27 illustrate perspective views of cooling pouches having one or more portions composed of long-term cooling material in accordance with one or more embodiments described herein.

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard).

While various components are illustrated as separate components, it will be appreciated that multiple components can be implemented as a single component, or a single component can be implemented as multiple components, without departing from the spirit and scope of the example embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. Further, measurements shown in the drawings herein are mere examples for illustration purposes, and the embodiments described are not limited to such measurements.

As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Humans suffer from overheating or hot flashes from menopause, exercise, inside/outside temperatures and/or activities. Unfortunately, existing cooling material typically employs a cooling finish on the material that is only temporary and washes away after repeated wear, uses fabrics that absorb water for temporary cooling until the water evaporates, cool by facilitating air flow to the body via insertion of a mesh pattern in the material, claim cooling by wicking and/or cool by yarns such as polyester or other yarn which provide quick dry or easier air flow throughout the fabric in order to feel a cooling sensation. Accordingly, systems, articles of manufacture and processes that facilitate long-term cooling that can reduce skin temperature are desired.

One or more embodiments described herein includes systems and articles of manufacture employing long-term cooling material and/or processes to generate the long-term cooling material and/or articles of manufacture. One or more embodiments described herein advantageously provide systems, articles of manufacture and/or methods employing long-term cooling material. As used herein, in some embodiments, the term “long-term cooling material” means cooling material that does not only temporarily cool for a limited number of hours or washes or until a coating wears off the material. In some embodiments, the term “long-term cooling material” means cooling material that cools based on the composition of the material (as opposed to cooling based on placing the material in cool water or a refrigerated area, for example). In some embodiments, the term “long-term cooling material” means permanently cooling material that maintains cooling substantially for the life of the material. In some embodiments, the term “long-term cooling material” means cooling material that is configured to cool by reducing the temperature of the skin of the wearer/user of the material (as opposed to applying mesh inserts in the material or using quick dry fabric).

The long-term cooling material described herein can be in the form of yarn or fabric. As used herein, “yarn” refers to the string or fiber that is knit, weaved or otherwise manipulated to create a fabric. Yarn can be composed of natural or synthetic fibers in various embodiments. As such, “fabric” is the yardage or body that is created from yarn and that from which patterns are cut to make either cut and sew garments or seamed garments. All such embodiments are envisaged herein. Further, when “long-term cooling material” is indicated, the disclosure includes and envisages yarn forms and/or fabric forms as applicable given the context being described.

In one embodiment, a cooling material is provided. The cooling material includes a yarn having a defined denier of less than or equal to approximately 70 denier and a defined yarn count; and a cooling mineral core disposed on the yarn and comprising nanosilver, wherein the cooling material is a material knit on a 28 gauge or greater knitting machine. In some embodiments, the defined yarn count is greater than or equal to approximately 36 rows per inch. In some embodiments, the defined yarn count is greater than or equal to approximately 42 rows per inch. In some embodiments, the defined yarn count is less than or equal to approximately 56 rows per inch. In various embodiments, the yarn includes at least one of Nylon 6, polyester, polyporopylene, polyacrylonitrile or rayon. In some embodiments, the cooling material is comprised within an article of manufacture comprising one of apparel, bedding and/or shoes.

In another embodiment, an article of manufacture is provided. The article of manufacture can include: a non-cooling material disposed to be positioned over two or more portions of the body; and a cooling material disposed to be positioned on the non-cooling material at selected locations indicative of areas of the body prone to overheating. The article of manufacture can be at least one of a wrap, a bandana, a scarf, a shoe, bedding, animal apparel or baby apparel.

In another embodiment, a method of manufacture is provided. The method can include: receiving, by a circular knitting machine, yarn having a composition disposed to provide cooling; knitting, by the circular knitting machine, the yarn; and outputting an article of manufacture as a garment in a form of a tube, wherein the outputting is resultant from the knitting. In some embodiments, the circular knitting machine is at least one of 28 gauge, 36 gauge or 40 gauge.

In yet another embodiment, a system is provided. The system comprises an article of apparel comprising a cooling material; and a pouch disposed to receive the article of apparel and configured to substantially maintain a first level at which the article of apparel is cooled. In some embodiments, the article of apparel comprises at least one a wrap, a shawl or a bandana. The pouch can be configured to obtain a second level of cooling based on placement of the pouch in a refrigerated region.

In yet another embodiment, a long-term cooling material is provided. The material can be knit on a 50 gauge machine. In some embodiments, the material is configured to lower a skin temperature of the skin of a wearer or user of the material in response to placement of the long-term cooling material adjacent the skin of the wearer or user.

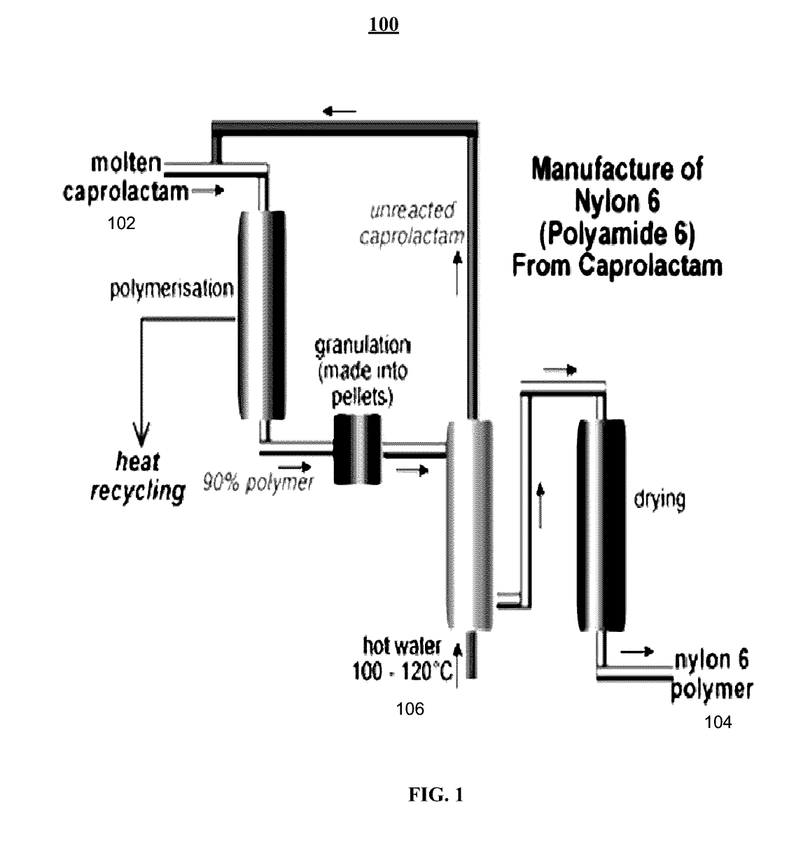

FIG. 1 illustrates a flow diagram of a process of manufacture of a nylon material according to one or more embodiments described herein. In particular, FIG. 1 illustrates the manufacture process of Nylon 6 as an example of a synthetic fiber creation process. For example, in particular in FIG. 1, the process 100 of polymerization of caprolactam 102 to Nylon 6 104 is illustrated.

In one or more embodiments, the long-term cooling fabric described herein can be or include polyamide 6 (which shall be referred to as “Nylon 6”) material. In one embodiment, Nylon 6 104 can be a nylon that has six carbon atoms in the monomer precursor, caprolactam 102. Nylon is made from large molecules called polymers, which are made from smaller caprolactam monomers. Nylon polymers are from the family called polyamides. As used herein, the term “nylon” can include, but is not limited to, a manufactured fiber in which the fiber-forming substance is any long-chain, synthetic polyamide in which less than 85 percent of the amide linkages are attached directly to aromatic rings.

Process 100 is a monomer to polymer process for creation of Nylon 6 104 material employed in one or more embodiments of the cooling fabric described herein. The Nylon 6 104 material is one embodiment of the long-term cooling material described herein. As shown in FIG. 1, the precursor ingredients to Nylon 6 104 are the monomer, caprolactam 102, and water 106. Caprolactam 102 is an organic compound, which therefore contains carbon, and which is synthesized from byproducts of the petroleum industry. Caprolactam 102 can be the primary ingredient in many forms of plastic.

A monomer is a molecule that can bond to other molecules of the same type to form larger molecules called polymers through a polymerization process. The process shown in FIG. 1 in which Nylon 6 104 is created from caprolactam 102 is called polymerization. In the embodiment shown, the polymerization of caprolactam 102 can occur through a transformational process called ring opening polymerization (ROP). In the ROP process, caprolactam 102 is heated with water to a temperature of approximately 265° Celsius, and processed for up to eight hours. During the process, the water 106 is removed and the caprolactam 102 monomers rearrange their molecular orientation from a closed ring structure to a straight chain structure. Then the straight chain molecules can bond to each other creating the polymer, Nylon 6 104. In some cases, the product of an ROP process is referred to as a melt. The melt product can then be treated to remove any unreacted caprolactam 102 and processed into the desired form. For the embodiments described herein, the Nylon 6 104 can be processed into pellets or chips for use in an extruder. Because the Nylon 6 104 can be a first embodiment of a long-term cooling material, the long-term cooling material will be referred to by the same reference number 104 as long-term cooling material 104 in some embodiments described herein.

While the process for generating Nylon 6 104 is shown in FIG. 1, in other embodiments, other synthetic yarns can be employed as long-term cooling materials (with or without cooling powder) in one or more embodiments described herein. For example, rayon can be employed.

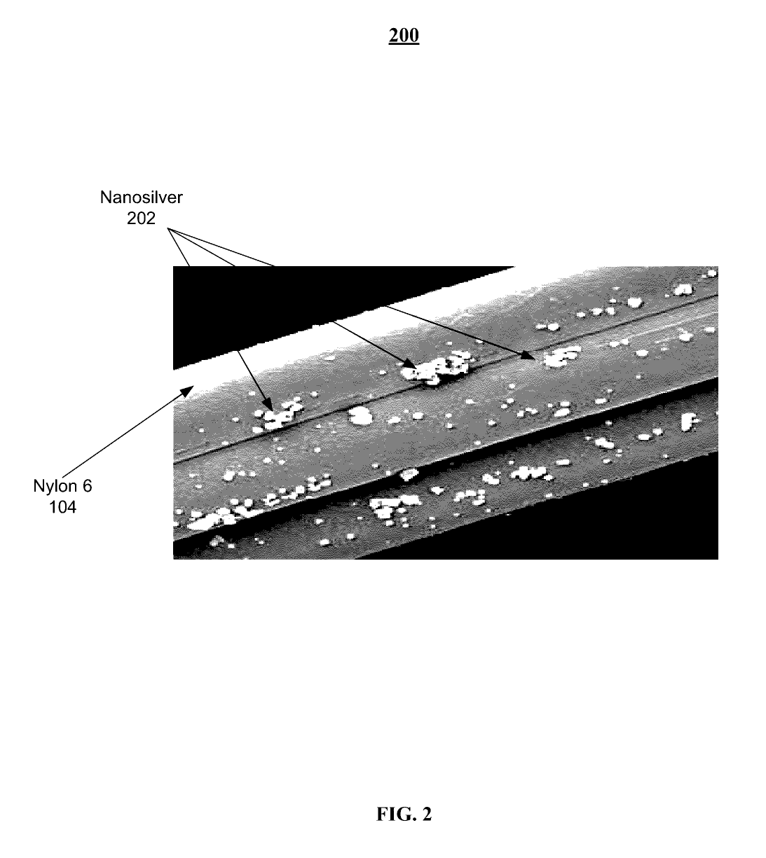

FIG. 2 illustrates a plan view of long-term cooling material including nanosilver according to one or more embodiments described herein. Repetitive description of like elements employed in other embodiments described herein is omitted for sake of brevity. In this embodiment, the long-term cooling material 200 can be or include Nylon 6 104 with nanosilver 202 added to the Nylon 6 104 before spinning the long-term cooling material 200 (which is composed of Nylon 6 104 and nanosilver 202) into fibers.

Accordingly, in some embodiments, the long-term cooling material is composed of Nylon 6 104 further processed via additive processing with nanosilver 202. The element, silver, has the highest thermal conductivity of any element at 430 Watts per meter per Kelvin. Accordingly, the nanosilver 202 can be added to the Nylon 6 104 in some embodiments to yield a desired thermal property of cooling in the resultant yarn or fabric. In particular, to create an embodiment of the long-term cooling material, nanosilver 202 can be added to the Nylon 6 104 before spinning the Nylon 6 into fibers. The addition of nanosilver 202 to the Nylon 6 104 can increase the thermal conductivity of the Nylon 6 104 fibers.

In some embodiments, the nanosilver 202 component of the cooling powders can be between approximately 20 nanometers (nm) and approximately 50 nm in diameter. As a basis for comparison, the cross-sectional diameter of an average cotton fiber is approximately 18 micrometers. Thus, the nanosilver 202 component of the cooling powders is much smaller than the cross-sectional diameter of an average cotton fiber. In other embodiments, other materials that can be combined with, knit with, or extruded into the Nylon 6 104 and/or other synthetic yarns as cooling powders or substances include, but are not limited to, jade, ceramics, bamboo and/or linen.

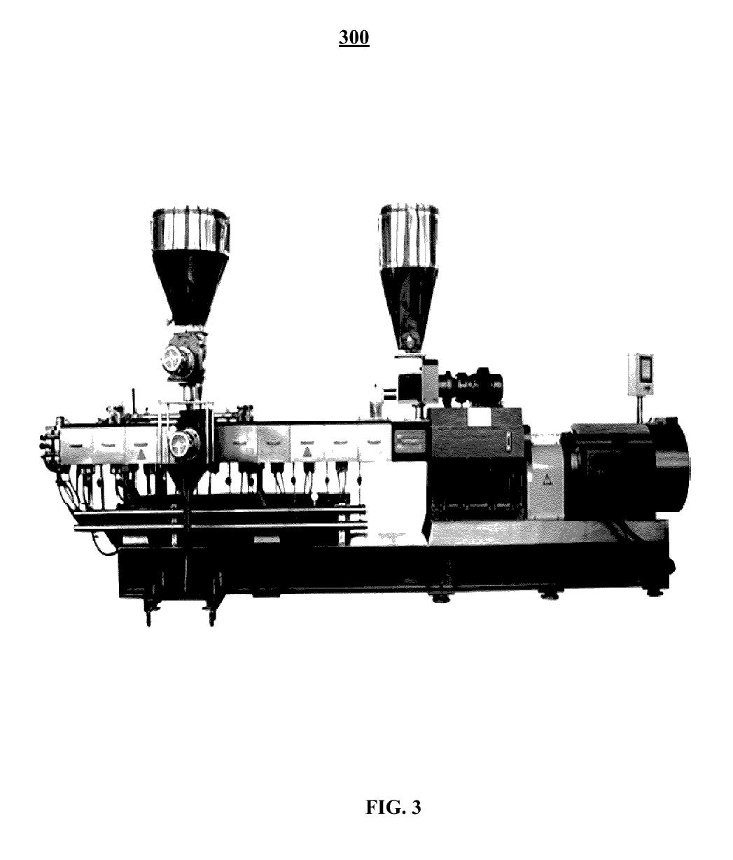

FIG. 3 illustrates a schematic diagram of a twin extruder configured to manufacture the second embodiment of the long-term cooling material including nanosilver according to one or more embodiments described herein. Repetitive description of like elements employed in other embodiments described herein is omitted for sake of brevity.

The extruder 300 shown in FIG. 3 is a twin-screw extruder. The extruder 300 can be employed to combine the Nylon 6 104 polymer with the nanosilver 202 cooling powders to yield the second embodiment of long-term cooling material. The twin-screw extruder 300 is a fiber manufacturing equipment that can employ heat to melt the Nylon 6 104 polymer and can apply pressure to squeeze the melted Nylon 6 104 polymer into one or more different desired forms. During the process of melting the Nylon 6 104, nanosilver 202 can be added to the Nylon 6 104 polymer at a controlled rate to improve the likelihood of obtaining a fairly uniform distribution of nanosilver 202 in the final long-term cooling material 200 that results. In various embodiments, the nanosilver 202 can be distributed over the surface of the Nylon 6 104 and/or throughout the Nylon 6 polymer. Accordingly, in some embodiments, fairly uniform distribution occurs in one dimension on the Nylon 6 104 while in some embodiments, fairly uniform distribution occurs across at least two dimensions within and on the Nylon 6 104. By way of example, but not limitation, in some embodiments, the nanosilver 202 can be added at a substantially uniform rate during one or more periods of the extruding process and/or throughout the entirety of the extruding process. For example, the nanosilver 202 (or, in other embodiments, any of the one or more possible cooling powders and/or substances) can be added at an equal or substantially equal rate as that of the rate at which the Nylon 6 104 (or other synthetic yarn) is added during the melting process. Deposits of the cooling powder/substance and the Nylon 6 104 synthetic yarn are therefore uniform or substantially uniform.

Once squeezed from the extruder, the doped Nylon 6 104 filament can be cooled and fed into a pelletizing machine. The final product can be chips or pellets of the second embodiment of the long-term cooling material (e.g., long-term cooling material 200), which includes Nylon 6 104 doped with nanosilver 202. The doped pellets can then be made into thermoconductive nylon fibers.

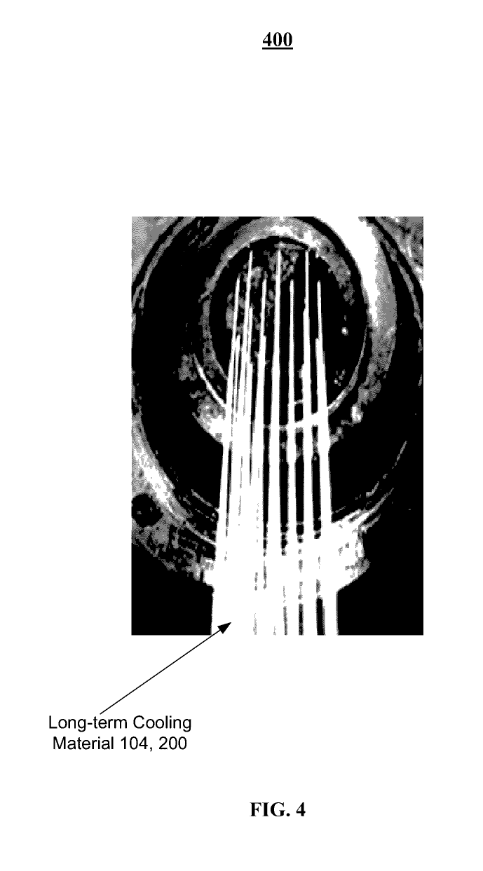

Fiber to yarn production of the long-term cooling material described herein can be as follows. Nylon fibers can be produced through a process called melt spinning, in which melted chips of doped Nylon 6 (e.g., long-term cooling material 200) can be extruded though a nozzle called a spinneret 400 (an example of which is shown in FIG. 4). The extruder spinneret 400 can form the melt into individual fibers as the long-term term cooling material 104, 200 is squeezed through the nozzle holes. After the fibers leave the extruder spinneret 400, the fibers can be cooled and start to become solid.

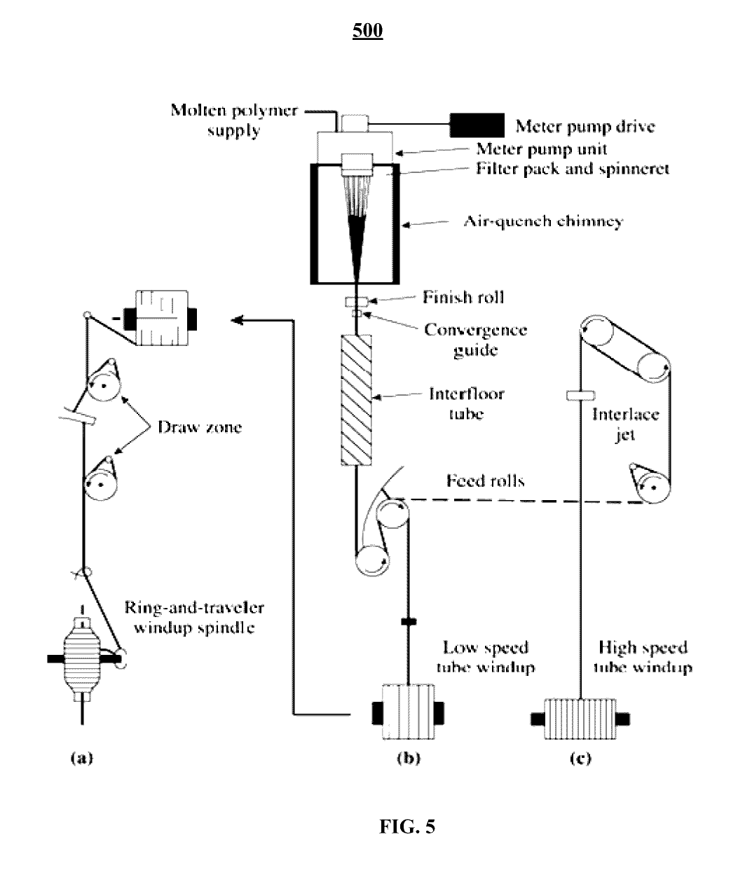

FIG. 5 illustrates a flow diagram of a process of yarn drawing the first or second embodiment of the long-term cooling material according to one or more embodiments described herein. Repetitive description of like elements employed in other embodiments described herein is omitted for sake of brevity.

The process 500 of fiber to yarn production includes the process of yarn drawing. In various embodiments, the spun long-term cooling material 104, 200 fibers can be drawn (stretched), crimped (texturized), twisted, and/or wound. The drawing process 500 can be performed to strengthen the fiber. Tightly drawn yarns are typically stronger (e.g., have higher tenacity) than loosely drawn yarns because drawing can cause the polymer molecules to become highly oriented and crystalline. For example, fully drawn yarn can be highly oriented and crystalline. However, these highly oriented yarns are typically stiff and are mainly used for technical and industrial applications. As such, for the apparel embodiments described herein, partially oriented yarns with medium tenacity can be created.

As with most partially oriented yarn (POY) processes, uniform (or substantially uniform) quenching can be employed to provide a consistent poly lactic acid (PLA) POY fiber with acceptable draw tension variation and/or denier uniformity. In some embodiments, quench air is provided to the yarn filaments between 30 to 70 millimeters (mm) from the face of the spinneret 400 for most yarn counts. An initial recommended setting of 0.55±0.1 meters per second quench velocity with a stable quench air temperature in the range of 18-22° Celsius (C.) (64-72° Fahrenheit (F.)) can be employed. Depending on actual yarn count, filament spacing and/or machine design, these conditions (quench delay, velocity and/or temperature) will vary and can be adjusted within defined ranges to obtain acceptable draw tension uniformity and/or denier uniformity values.

Medium tenacity fibers have an elongation between approximately 45 percent and approximately 150 percent. Tenacity can be expressed in centiNewton (cN)/tex in some embodiments. In these cases, medium to high tenancy yarn can be between approximately 72 cN/tex to approximately 78 cN/tex. High to super high tenacity yarn can be between approximately 80 cN/tex and approximately 85 cN/tex.

Table 1 shows the tenacity, or breaking strength, of various natural and manmade fibers.

TABLE 1

| | Breaking Strength (cN/tex) |
|---|---|
| Fiber | |
| Cotton | 15-40 |
| Cellulosic Manmade Fibers | |
| Viscose/rayon | 23-30 |
| Modal | 32-38 |
| Lyocell/Tencel | 39-50 |
| Synthetic Manmade Fibers | |
| Polyester | 50-71 |
| Polyacrylic | 24-35 |
| Polyamide | 40-70 |

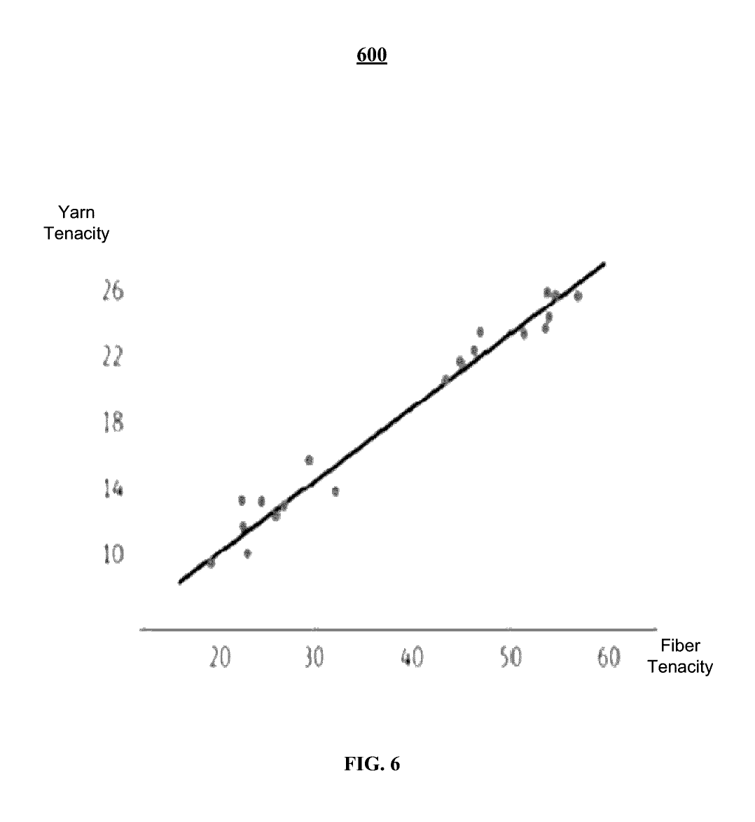

FIG. 6 is a graph illustrating the relationship between fiber tenacity and yarn tenacity in CN/tex according to one or more embodiments. With reference to FIG. 5, as or after the fibers are drawn, in some embodiments, crimp can be added by either a heat or a mechanical process. Crimping adds waviness to fibers and can produce yarns with more bulk. The fibers can then be twisted into a yarn and wound on a take-up core or spool. The industry term for this product is drawn textured yarn (DTY). The DTY can then be knitted into fabric, which can represent a third embodiment of the long-term cooling material (e.g., long-term cooling material 502). As shown in FIG. 5, section A is a draw twist process, section B is a conventional spinning process and section C is a coupled process.

One or more embodiments of the long-term cooling material 502, 104, 202 described herein can be thermoconductive, eco-friendly, anti-microbial, and/or provide ultraviolet (UV) protection. By way of example, but not limitation, the long-term cooling material 502, 104, 202 can be eco-friendly because the long-term cooling material 502, 104, 202 can be produced from byproducts that would otherwise become waste (as described with reference to FIG. 1), and/or because the production of long-term cooling material 502, 104, 202 requires few chemicals to clean the fiber, unlike natural fibers. The long-term cooling material 502, 104, 202 can provide UV protection because of additives added during manufacturing to become UV resistant and/or because the tight knit of the weave at least partially blocks UV light (in addition to, in some embodiments, the darkness or lightness of the color of the long-term cooling materials 502, 104, 202 can facilitate at least partially blocking UV light). One or more embodiments described herein can completely or at least partially block UV spectrum light.

With regard to thermoconductivity, silver is the most thermoconductive element known. As such, the embodiments of the long-term cooling material described herein that include a coating of nanosilver 202 on the Nylon 6 104 can have positive cooling thermoconductive properties. In some embodiments, however, nanosilver 202 need not be employed for thermal performance. For example, in various embodiments of long-term cooling material 104, which does not include nanosilver 202, one or more of the fiber shape, degree of crimp, weave pattern, knit pattern and/or yarn count can be changed to obtain different thermoconductive properties. In various embodiments, since hollow yarns tend to be warmer and not ideal for cooling fabrics; the more open a knit using a non-cooling yarn, the cooler the yarn will be as the yarn lets airflow through. Crimped yarns typically hold heat in and keep the wearer warmer. Straight, round drawn yarns are ideal for cooling fibers. Accordingly, in some embodiments, using substantially straight, round drawn yarns can be employed for one or more embodiments of long-term cooling material 502, 202.

In some embodiments, the long-term cooling material 502, 202 can be anti-microbial based on the addition of nanosilver 202 to Nylon 6. For example, the addition of nanosilver 202 to the Nylon 6 104 can add antimicrobial properties to the yarn or fabric. The antimicrobial effect is obtained through the function of nano silver 202 ions on microorganisms. The nanosilver 202 reacts with the molecules in the microorganism and deactivates the molecules. Nanosilver 202 is often more effective against microbes than antibiotics because the microbes do not easily build up a resistance to nanosilver 202.

The heat flux in the long-term cooling material 502, 104, 202 can be measured to represent the cool or warm feel of the long-term cooling material 502, 104, 202. The Q_{mAx} is an industry standard term for representing the cool and warm feeling of fabrics. The Q_{mAx} describes the heat flux that flows out of a heated copper plate onto the surface of a fabric when the plate and the fabric touch. Qₘₐₓ is used to assess the instantaneous thermal feeling sensed during initial contact of the yarn or fabric with the skin surface. Q_{mAx} measures thermal transport in watts per square meter Celsius. The Kawabata Evaluation System (KES) is becoming the industry standard for evaluating thermal properties of fabrics.

Nylon material intended for apparel is typically manufactured as a multifilament yarn or, as short staple fibers to be spun into yarns intended to mimic wool or cotton. Nylon has the appearance of translucent glass, and one or more embodiments of the long-term cooling material 502, 104, 200 described herein can be delustered and/or solution dyed during the manufacturing process to add color. The long-term cooling material 502, 104, 200 employed herein has a strong affinity for dyes and can be colored in deep hues, for example. The cross-sectional shape of the long-term cooling material 502, 104, 200 can be altered to change performance characteristics such as fabric texture (hand), drape, moisture wicking, or thermal properties.

With regard to durability, the long-term cooling material 502, 104, 202 has superior durability and can exhibit excellent strength, high elongation and abrasion resistance. In some embodiments, a filament of the long-term cooling material 502, 104, 200 can have a wet/dry tenacity of 4.0-7.2/3.7-6.2, a breaking elongation of 17-45%, and an elastic recovery of 98-100%. Accordingly, the long-term cooling material 502, 104, 200 can be strong when wet or dry, recovers shape after stretching, and/or performs well in rough use.

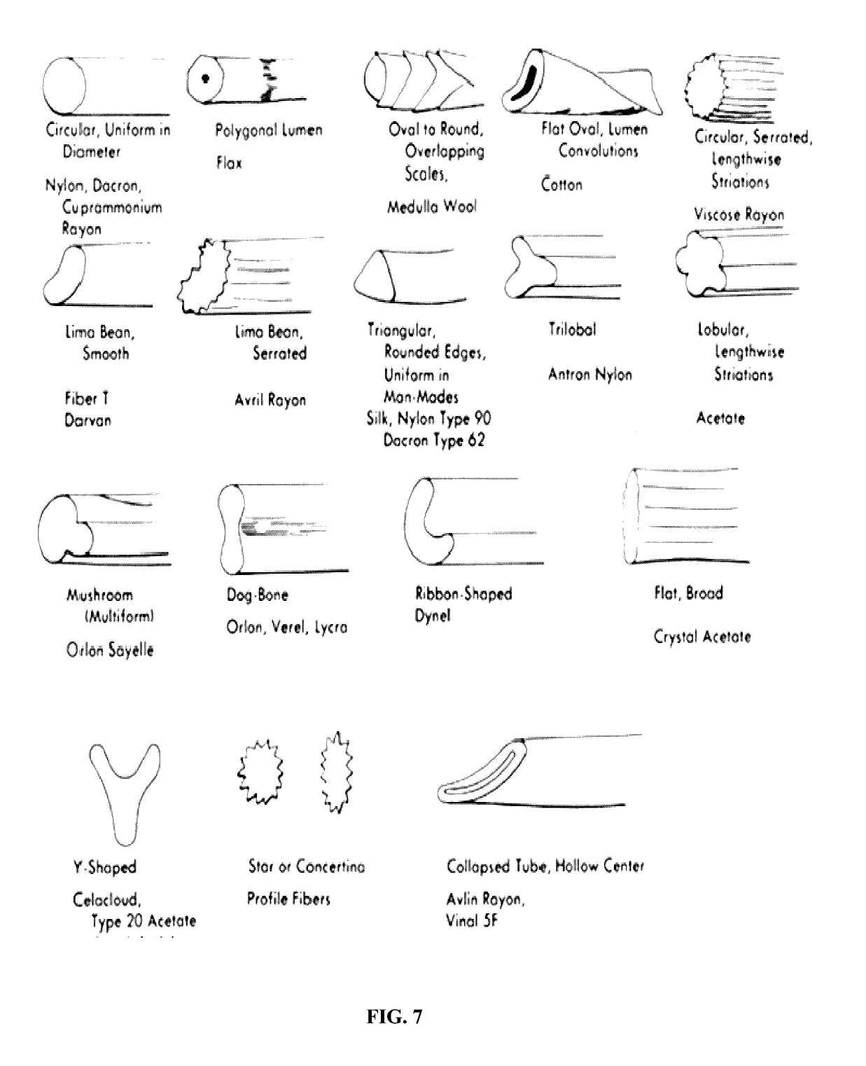

Traditional nylon material does not typically absorb moisture well, so fabrics can feel clammy to the wearer. Nylon also tends to generate static electricity during low humidity, and this can also be uncomfortable. In one or more embodiments described herein, the fiber of the long-term cooling material 502, 104, 202 can be modified to change and/or improve cross-sectional shape, crimp, and/or anti-static finish to increase comfort for the wearer of the long-term cooling material 502, 104, 202. Examples of different cross sections that can be employed for different embodiments of long-term cooling material are shown in FIG. 7.

With reference to one or more of the various embodiments described herein, the measurement of fibers and yarns as expressed herein is in denier, which is the common measurement for fineness of a fiber or linear density of a yarn. Specifically, a denier is the weight in grams of 9000 meters of the fiber or yarn. The dimensions recited are the approximate dimensions of the fibers or yarn in relaxed state. Smaller denier indicates finer fiber or yarn. Denier for yarn is expressed as total denier/quantity of uniform filaments. In one or more embodiments described herein, the long-term cooling material 502, 104, 200 can be cooling fabric yarn for example that is approximately 20d/7f. This means that 9000 meters of the yarn weighs 20 grams, and each (or, in some embodiments, one or more) filament weighs 2.86 grams (since 20/7=2.86). These values represent one mere example. In other embodiments of the long-term cooling material 502, 104, 200, the denier can be any suitable value for apparel, shoes and/or pouches, and can have one or more different values, as described herein.

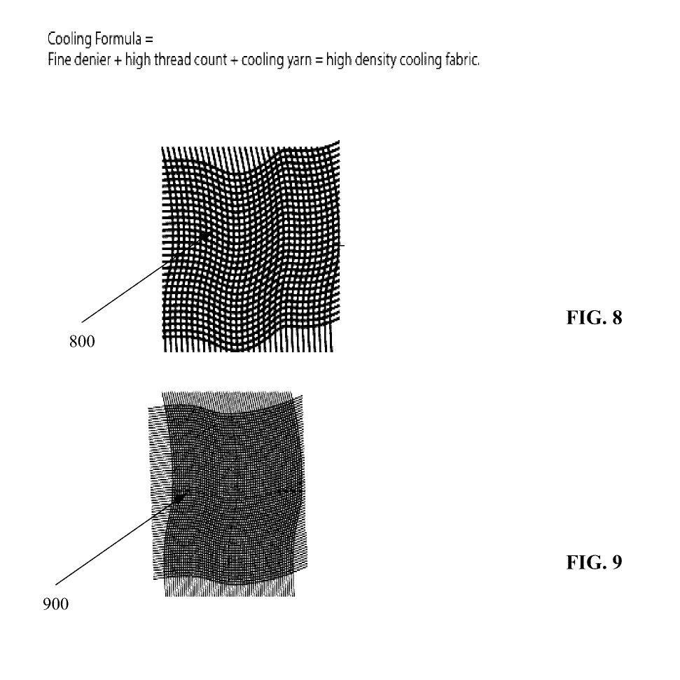

FIGS. 8 and 9 illustrate schematic diagrams of plan views of low and high density fabrics described herein according to one or more embodiments described herein. In some embodiments, the long-term cooling material described herein can be composed of high density fabrics. Repetitive description of like elements employed in other embodiments described herein is omitted for sake of brevity.

FIG. 8 shows a low density fabric 800 and FIG. 9 shows a high density fabric 900. As described herein, a low density fabric 800 can be a fabric that is below approximately 36 stitches per inch when counting across or horizontally and denier of yarn is above approximately 70. A high density fabric 900 can be a fabric that is above approximately 36 stitches per inch when counting across or horizontally and denier of yarn is below approximately 70.

In some embodiments, a formula for generating a long-term cooling material 502, 202, 104 can be or include a fine denier coupled with a high thread count (e.g., high density) and a cooling yarn (e.g., Nylon 6 yarn or Nylon 6 treated with nanosilver yarn). Accordingly, to obtain long-term cooling material in one or more of the embodiments described herein a combination of a fine denier yarn (e.g., less than or equal to approximately 70 denier) can be employed with a defined tightness of the weave or gauge of the fabric and a yarn having a cooling powder/cooling mineral powder/core. In some embodiments, the combination can also include an optional cooling topical treatment.

Although the embodiments described thus far have included Nylon 6, in various embodiments, the long-term cooling material described herein need not be composed of or include Nylon 6. By way of example, but not limitation, the long-term cooling material can be or include one or more of various synthetic yarns such as polyester, polyporopylene, polyacrylonitrile, rayon, or other fibers.

In some embodiments, whether the long-term cooling material includes Nylon 6 or includes one or more of polyester, polyporopylene, polyacrylonitrile, rayon, or other fibers, the long-term cooling material can be or include high thermal diffusivity and low thermal conductivity mineral composite powder that is ground into a powder and spun with the Nylon 6, polyester, polyporopylene, polyacrylonitrile, rayon, or other fibers. In some embodiments, the cooling mineral powder can be made of nanosilver 202 and can be spun into, knit with and/or extruded with varying synthetic yarns such a Nylon 6, polyamide nylon generally, polyester, polyporopylene, polyacrylonitrile, rayon, or other fibers. In some embodiments, other cooling powder alternatives such as ground Jade and/or ceramics can be included as the cooling powder/cooling mineral powder/core.

The denier of the long-term cooling material yarn can be a denier that is fine enough to be knit on a 36, 40, 50, or 60 gauge machine, and the long-term cooling material fabric can be a high thread count or have a high number of yarns/inch. In defining the denier of the fiber, the fiber can be 70 denier or below to achieve the long-term cooling material described herein. In some embodiments, the denier can be 50 denier, 40 denier, 30 denier, 20 denier or 15 denier (although other denier below 70 can alternatively be employed).

The fine gauge or tightly knit/woven fabrics are defined as or include fabrics having a minimum of 36 rows or threads per inch. The higher the number of rows or threads per inch, the finer and more compact the fabric. Thus, in some embodiments, fine gauge fabric can be fabric having approximately 36 threads or yarns per square inch, which can offer the coolest or most impact of cool by weaving or packing in the cooling yarns tightly. In one embodiment, for jersey knit, the yarns or rows of the long-term cooling material can be approximately 56 rows per inch. In some embodiments, the count can be from 36 rows per inch to above 56 rows per inch in some embodiments. The count can be from 42 rows per inch to above 56 rows per inch in some embodiments. The long-term cooling material can feel less cool as the number of row/inch decreases.

Accordingly, the aspects of a mineral core yarn combined with fine denier yarn and high yarn count can be the aspects and/or process for creating the long-term cooling material. In some embodiments, a cooling, topical finish can also be added (although such is not necessary). The cooling, topical finish can increase the cooling of the long-term cooling material further even more but may only temporarily increase coolness as the finish may wash out in approximately 25 washes.

In some embodiments, the fine denier fabric as described and specified herein is a high density fabric. For the embodiments described herein, the following components can be employed to obtain one or more embodiments of long-term cooling material: fine gauge, high density fabric in which the yarns are “packed in” and have a minimum of 36 count per inch. Low density fabrics are not as cold as high density fabrics and therefore may not be employed in one or more of the embodiments described herein. In some embodiments, the values can be maintained irrespective of the type of synthetic base yarn employed to nonetheless achieve a cool sensation via the long-term cooling material.

One or more embodiments described herein include long-term cooling materials that offer cold physical touch to the skin and/or articles of manufacture that include such long-term cooling materials.

Yet another embodiment of the long-term cooling material can be a combination of nylon and spandex. By way of example, but not limitation, the long-term cooling material can be composed of 30% or more nylon and 70% or less spandex. In some embodiments, the long-term cooling material can be a combination of different materials. For example, the long-term cooling material can include various synthetic or natural fiber blends such as polyester, rayon, viscose, acrylic, cotton, silk, linen and/or hemp. As another example, the long-term cooling material can be knit with a yarn that contains CUPRON®, silver, polyester, rayon, viscose, acrylic, cotton, silk, modal, hemp and/or bamboo.

Different embodiments of the articles of manufacture described herein can be constructed using cut and sew methods or by knitting any of the embodiments of the long-term cooling material described herein on a seamless, hosiery, or sweater machine. By way of example, but not limitation, in some embodiments, by seamless or circular knitting, the articles of manufacture described herein can be advantageously converted from a yarn form of the long-term cooling material directly to garments, bedding and/or shoes without intermediate conversion to fabric.

The process for converting the yarn into a garment on a circular machine is called seamless or circular knitting. The Santoni seamless knitting machines are examples of those that can be employed in the embodiments described herein. In various embodiments, the circular knitting machinery can be 28, 36, 40, 50 or 60 gauge. The method of employing the circular knitting machine to manufacture apparel, shoes and/or other products from the long-term cooling material can be as follows in some embodiments.

The yarn form of the long-term cooling material can be fed onto the circular knitting machine. As the machine knits the yarn, the article of manufacture is a cylinder, circular, or tubular article of manufacture. The knitting of the article of manufacture can include cut lines for adding an inseam; cut lines for adding straps; cut lines for adding leg holes or armholes. The knitting can also include knit-in holes for ventilation or to provide a mesh look. The circular or seamless knitting machine outputs the resultant article of manufacture as a garment in the form of a tube. The machine knits garments one at a time. Seamless machines can have different cylinder sizes from 4 inch to 20 inch depending on the end use of the garment. For example, a 4 inch machine can typically be employed to produce legs of tights or hosiery while a 20 inch machine can be employed for the torso of a man's shirt.

The seamless or circular machine can be employed in the embodiments described herein with the long-term cooling material in the form of fabric. For example, the yarn form of the long-term cooling material can be input into the seamless or circular machine and the above-described circular knitting process can be employed to generate various embodiments of the apparel, bedding and/or shoes with the long-term cooling material described herein in a two-step process from the yarn form of the long-term cooling material directly to the garment, bedding and/or shoe.

By contrast to the seamless or circular knitting approach, a garment made via the cut and sew method includes the maker employing pattern pieces. The maker lays out the pattern pieces flat on fabric, and cuts the pattern pieces out of the fabric. The pieces are then sewn together to make a garment. In a seamless or circular garment, there are few or no seams. The garment is created within the seamless machine itself. For example, a camisole can be made on a seamless machine and the camisole will have no side seams and be output from the machine with an already knit-in hem. The only addition needed to create the garment is binding for the armhole and shoulder straps.

In the embodiments described herein, the apparel, bedding, shoes and/or any other products can be manufactured from the manufacture process employing seamless or circular machinery, via cut and sew methods and/or via traditional knitting or weaving methods.

In some of the embodiments described herein, knitting of the long-term cooling material can be performed on a 50 gauge machine. Knitting on a seamless machine that is 40 or 50 gauge can be employed to manufacture various embodiments of the apparel, shoes, and/or bedding described herein. In other embodiments, other gauges can be employed.

In various embodiments, the article of manufactures described herein can be stitched together with one or more of zigzag, straight stitch, cover stitch, flat lock, over lock, marrow, serged, bonded, and/or ultrasonic stitching method.

The embodiments described herein include articles of manufacture employing long-term cooling material configured to provide cooling of the skin and/or reduce or avoid heat discomfort. As used herein, the articles of manufacture can be any number of different types of apparel, bedding, consumer soft goods and/or shoes/boots that include and/or are composed of long-term cooling material. The embodiments of apparel described herein can include, but are not limited to, camisoles, tank tops, short sleeve tee shirts, long sleeve tee shirts, cardigans, sweaters, shorts, jackets, coats, leggings, undergarments (e.g., slips, brassieres, panties, briefs, girdles, mid-thigh shorts), skirts, burkas, mid-thigh shorts, socks, scarves, wraps, exercise apparel (e.g., exercise shirts, shorts, athletic wear and the like), hats, caps, bandanas and/or athletic apparel (e.g., shirts, pants, jackets, footwear, sweaters, hats, caps, athletic uniforms and athletic socks) as well as dresses, tunics, ponchos, culottes, and/or flowy or loose fitting apparel.

The embodiments of the soft goods described herein can include, but are not limited to, different types of bedding (e.g., pillow cases, pillow shams, bed fitted sheets, bed top sheets, duvet covers, duvets, comforters, quilts and/or blankets). Baby bedding can include baby bedding, bundle bags, swaddling blankets, fitted crib sheets, crib blankets, and/or diaper changing pad covers. Various products for animals (bed covers for dogs in dog houses), cooling vests for animals and the like are also envisaged.

The embodiments of the shoes described herein can include, but are not limited to, running shoes, tennis shoes, flip flops, boots, high heels, pumps, sling-backs, mules, shearling boots, slippers, rain boots, lace-up rubber soled shoes, loafers, espadrilles, lace-up walking shoes, sailing shoes and/or diving slippers. Pouches including or composed of long-term cooling material are also envisaged.

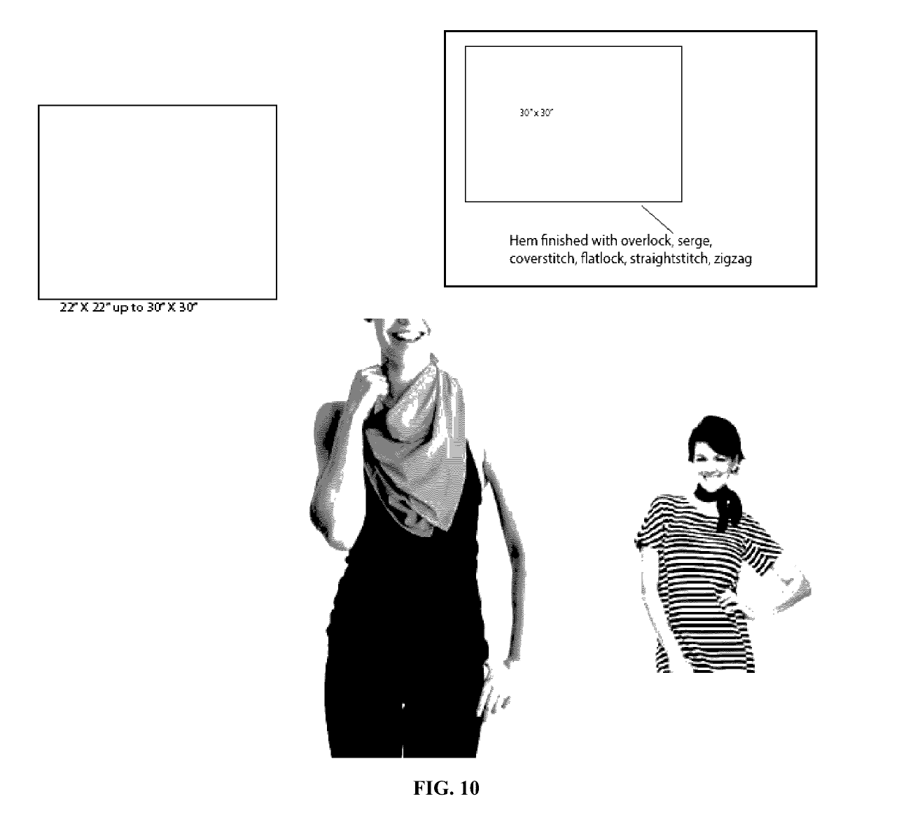

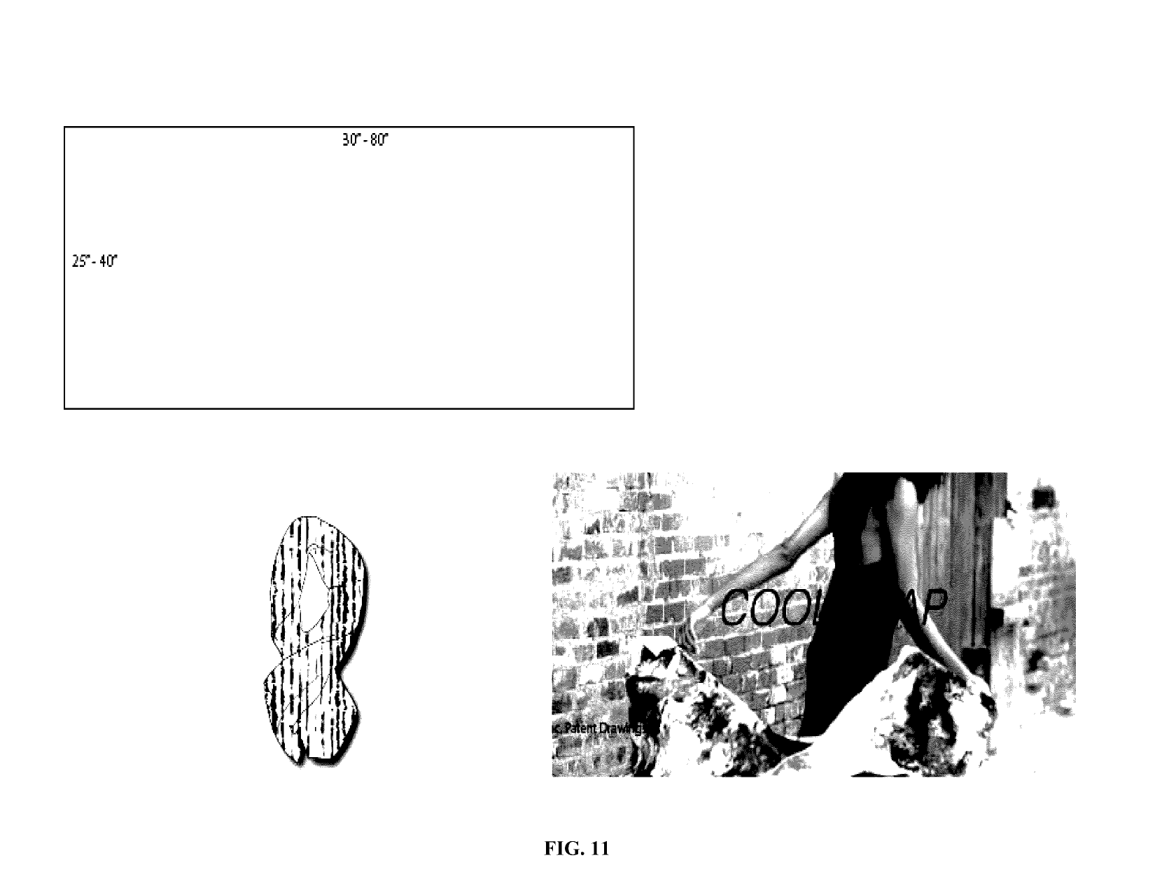

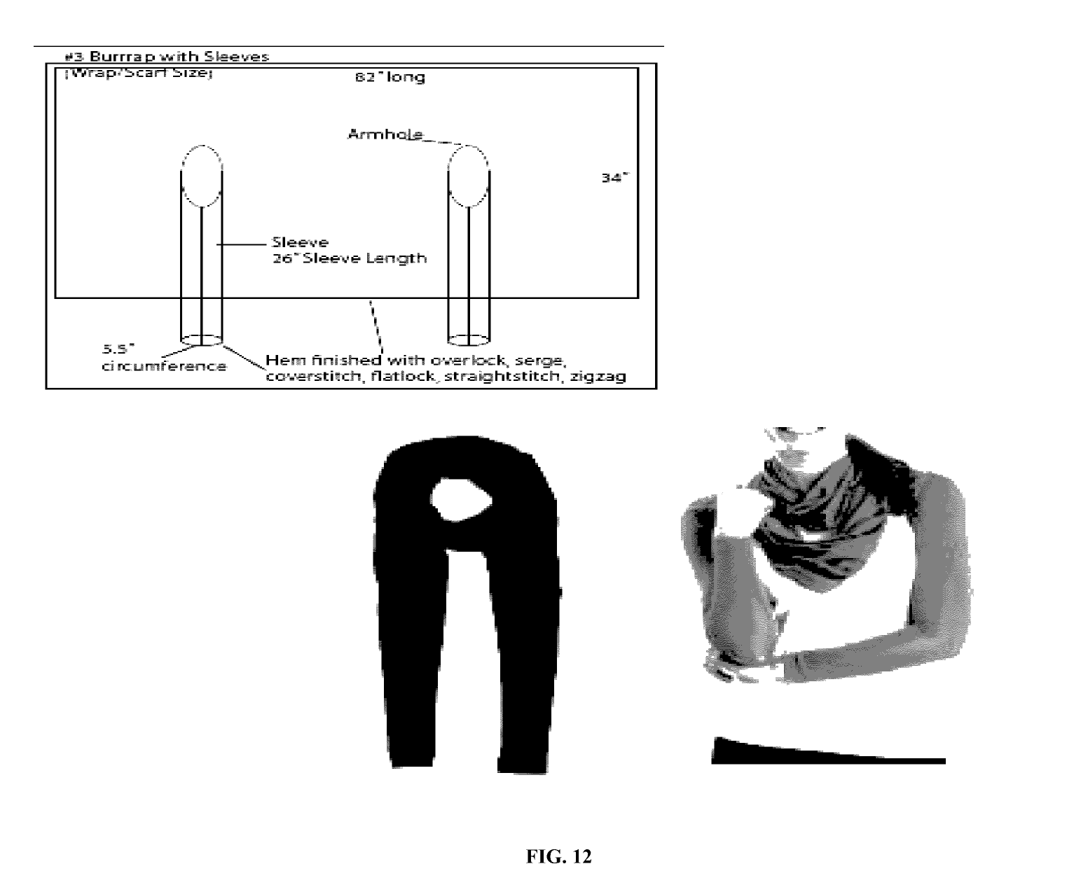

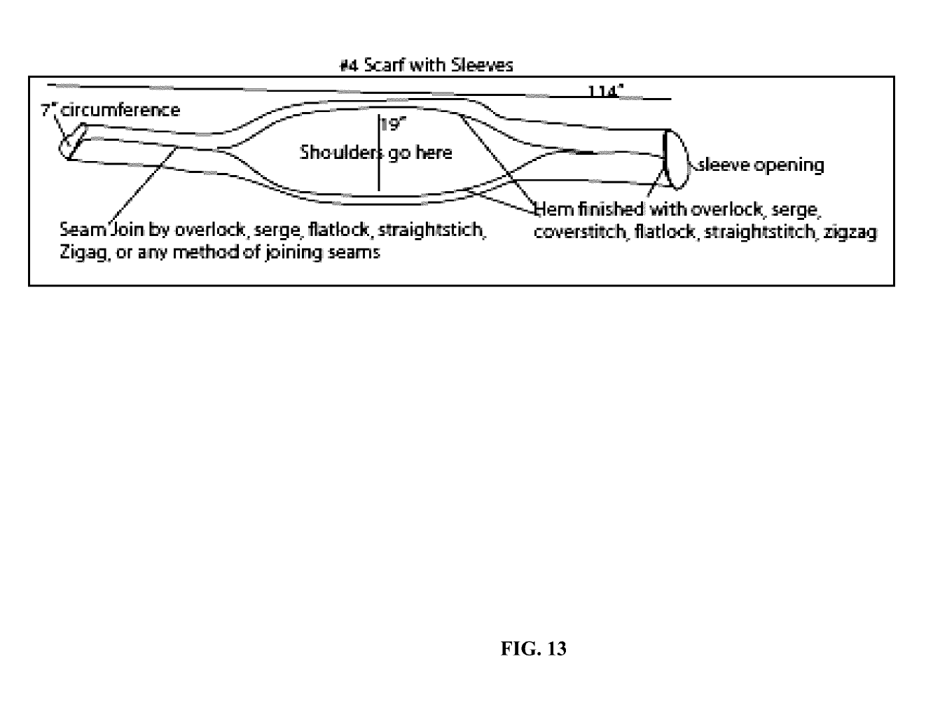

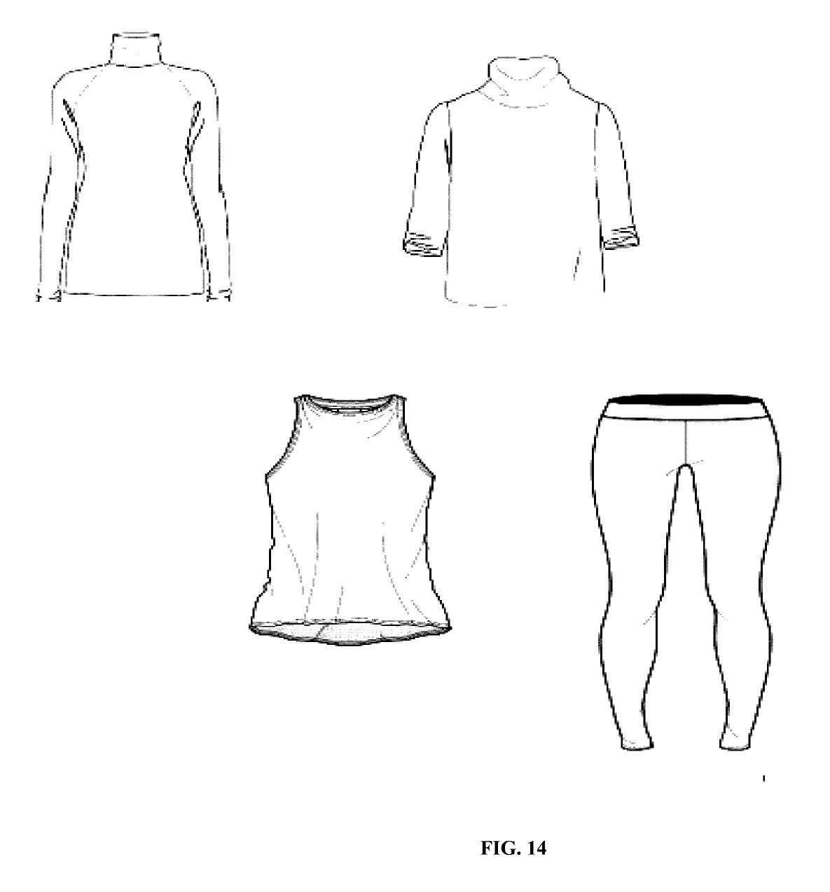

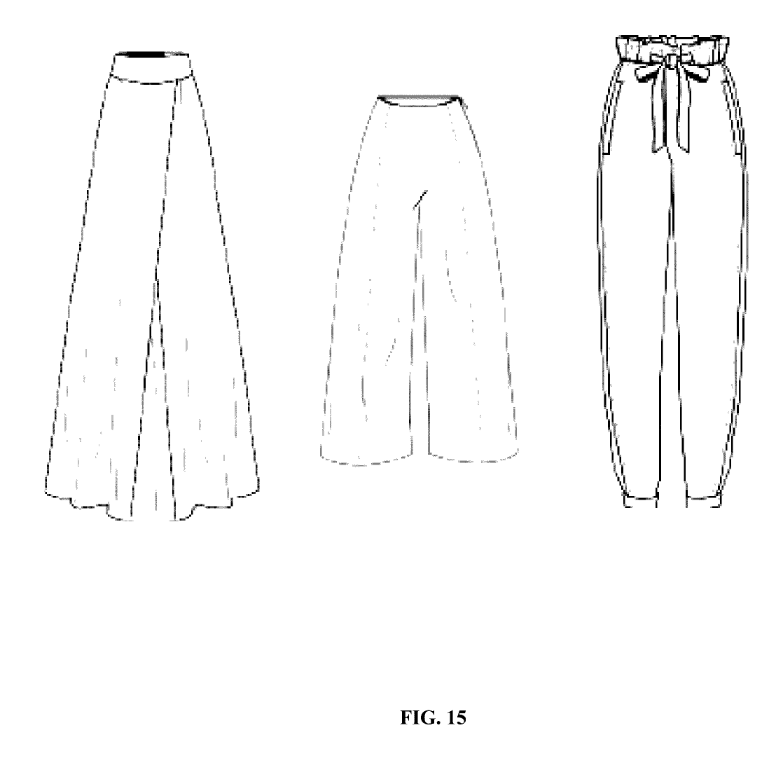

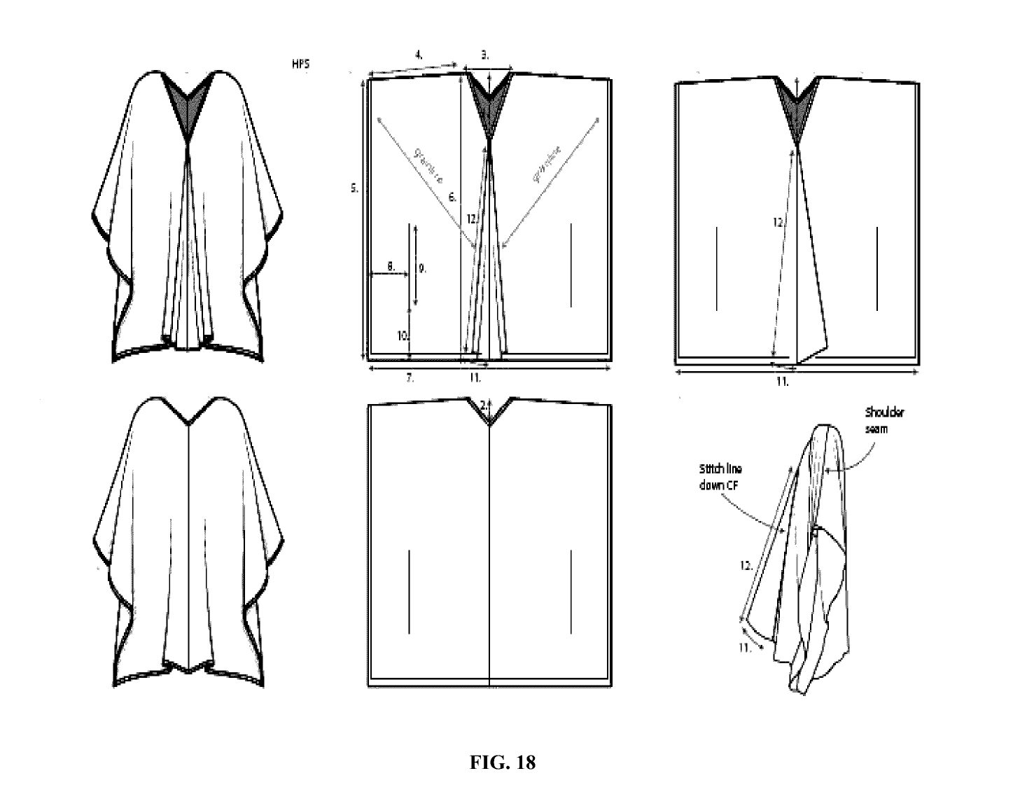

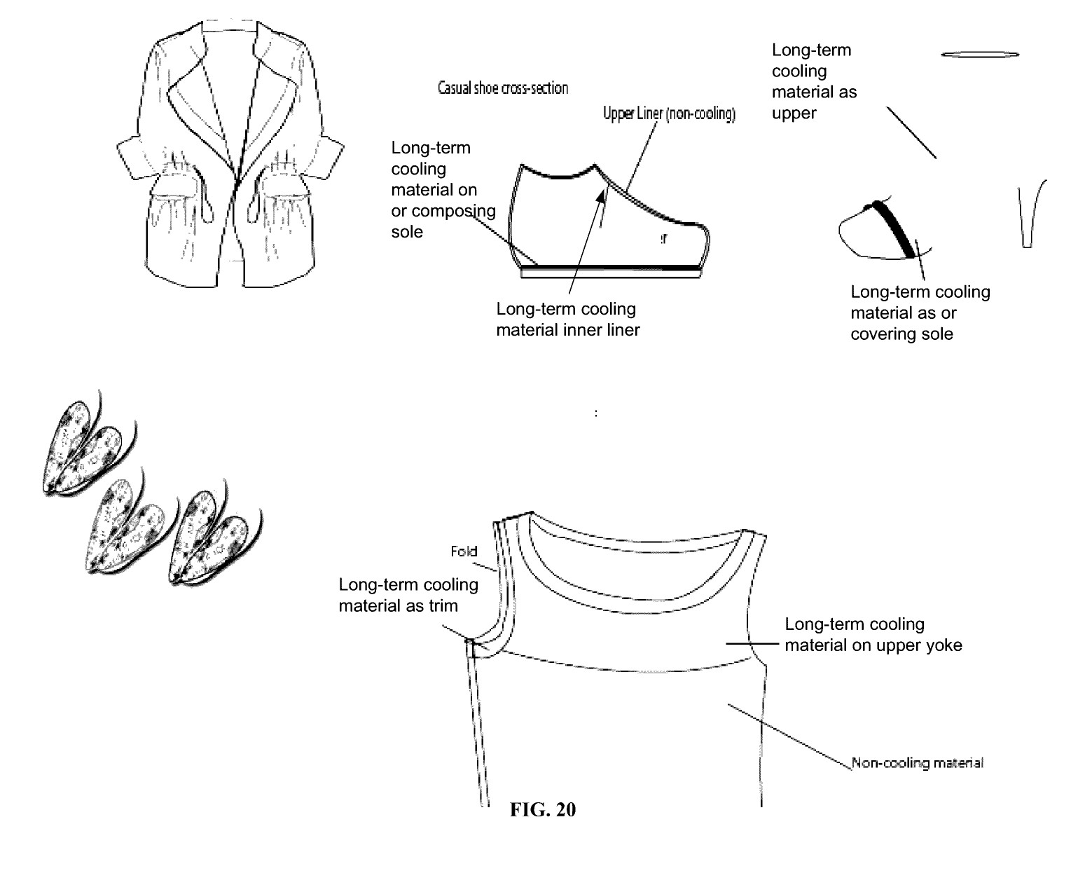

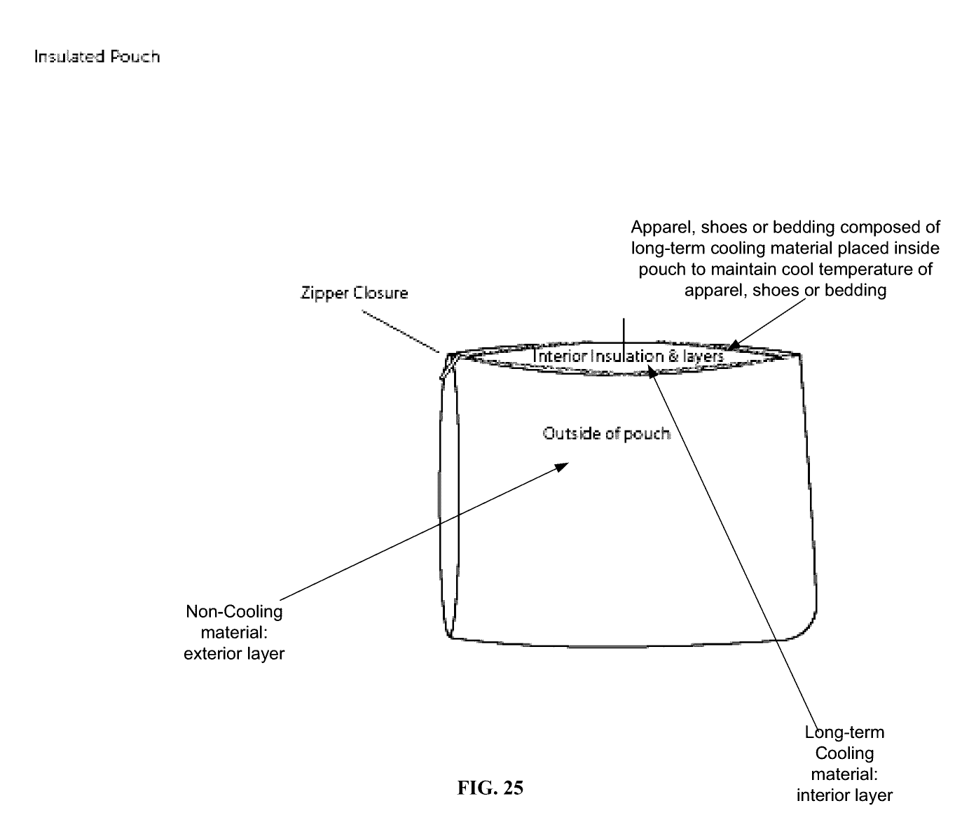

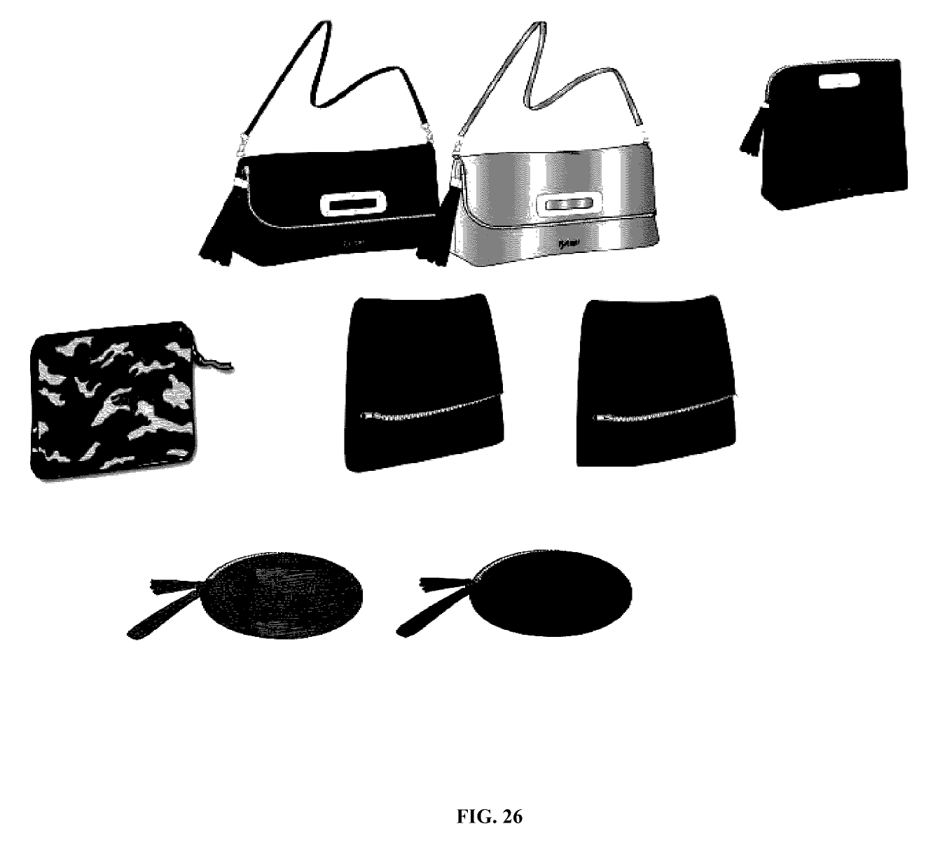

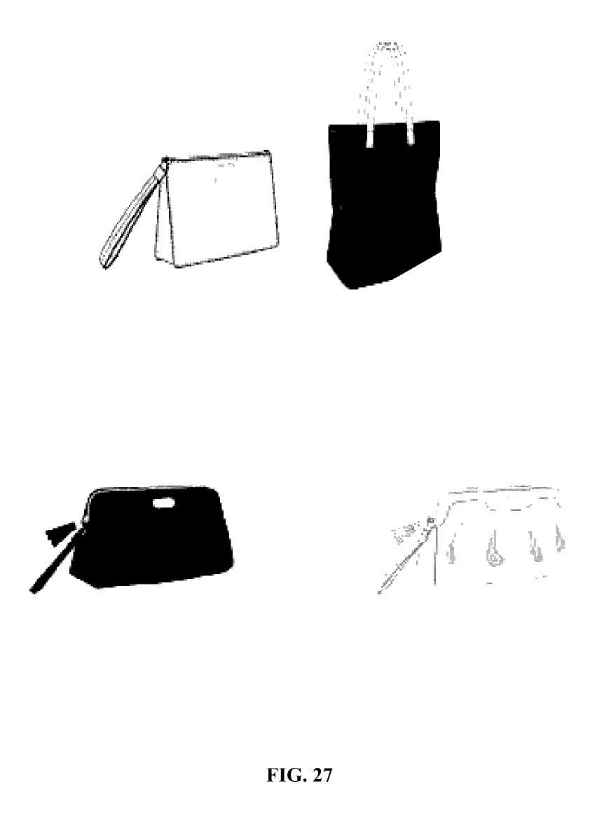

As shown in the drawings, embodiments of articles of manufacture that include and/or are composed of long-term cooling material can include, but are not limited to, apparel (e.g., scarves, shawls, bandanas, wraps, shirts, pants, culottes, dresses, skirts, jackets, undergarments, exercise clothing and athletic clothing) (see FIGS. 10-23), shoes and/or boots (see FIG. 20), consumer soft goods (e.g., bedding) (see FIG. 24), and/or pouches that can be used in conjunction with the foregoing articles of manufacture (see FIGS. 25-27)) that include and/or are composed of long-term cooling material. The dimensions shown in one or more of the embodiments are mere examples of possible dimensions and the articles of manufacture in the various drawings need not be so limited or designed. Specifically, other dimensions can be employed for the different articles of manufacture and all such variations are envisaged. Further, in various embodiments, one or more of the shapes and/or configurations of the articles of manufacture are mere examples and any number of shapes, combinations of long-term cooling material and non-cooling material, placement of long-term cooling material and/or placement of non-cooling material can be employed and all such variations are envisaged.

In various embodiments, the long-term cooling material can be used alone as a single layer material of which the article of manufacture is composed. For example, a wrap, a bandana, a scarf, dress, shirt, pants, pouch and/or bed top or fitted sheet can be composed of the long-term cooling material manufactured in the form of the end product that allows the end product to be worn or used by a consumer. While some articles of manufacture can be composed of a single layer of long-term cooling material, in some embodiments, an article of manufacture can be constructed with multiple (e.g., 2-4 layers of the long-term cooling material). The multiple layers can be provided for enhanced cooling. FIGS. 10-27 illustrate examples of articles of manufacture that can be composed of a single layer or multiple layers of long-term cooling material.

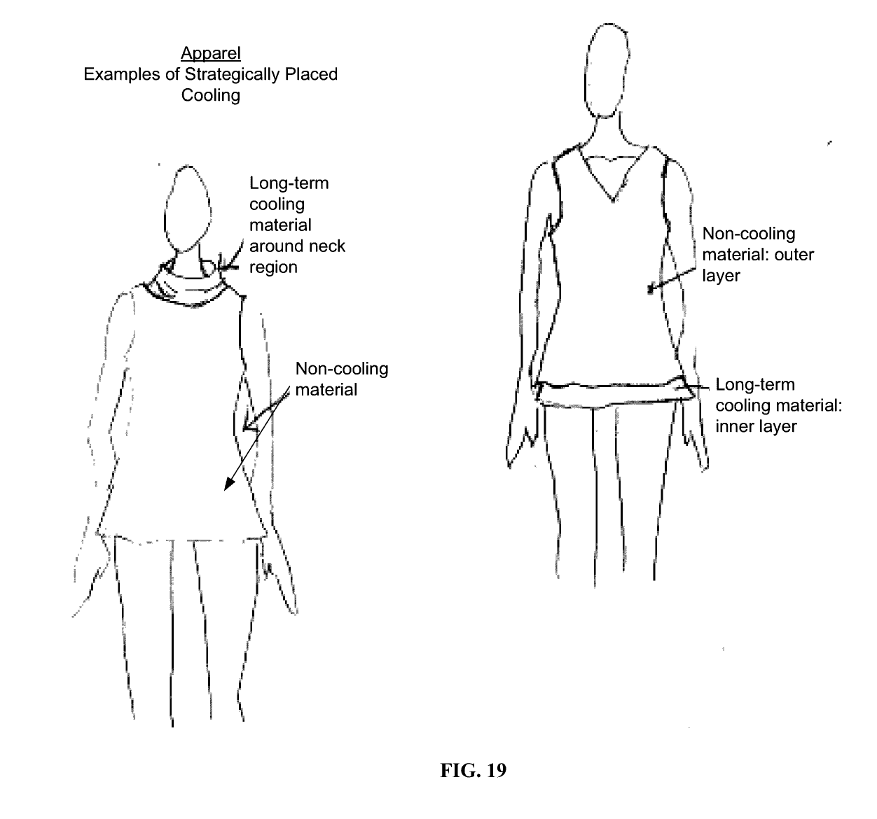

Any number of layers of long-term cooling material can be employed in a stacked formation to enhance cooling of the article of manufacture end product. Additionally, in some embodiments, one or more portions of an article of manufacture can include more or less layers of long-term cooling material than other portions of the same article of manufacture for strategically placed enhanced cooling. By way of example, but not limitation, multiple layers of long-term cooling material can be provided at the cowl neck region or turtle neck region of a blouse such as that shown at FIG. 19. By way of another example, multiple layers of long-term cooling material can be placed at the upper yoke and trim of the tank top shown in FIG. 19.

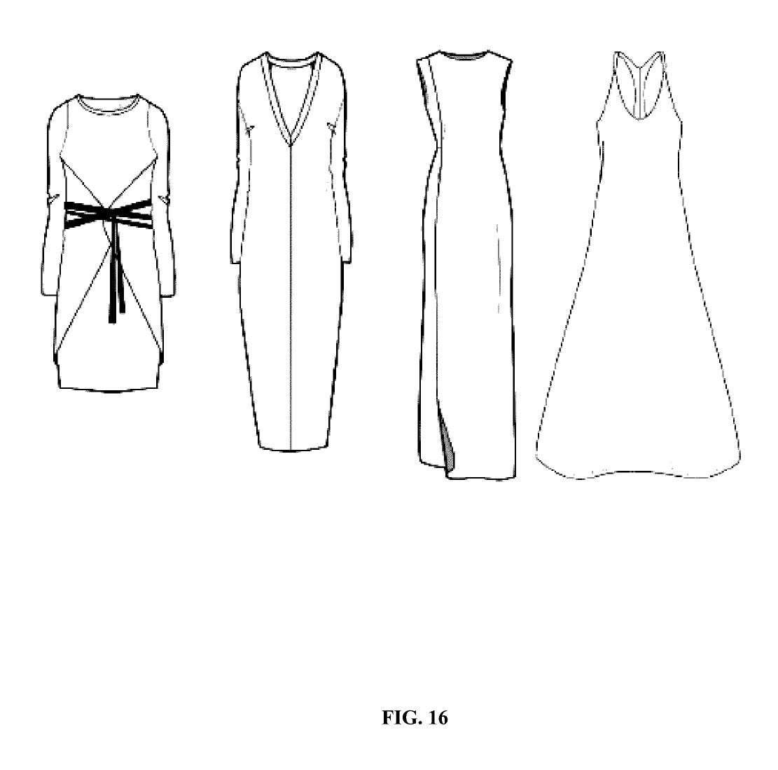

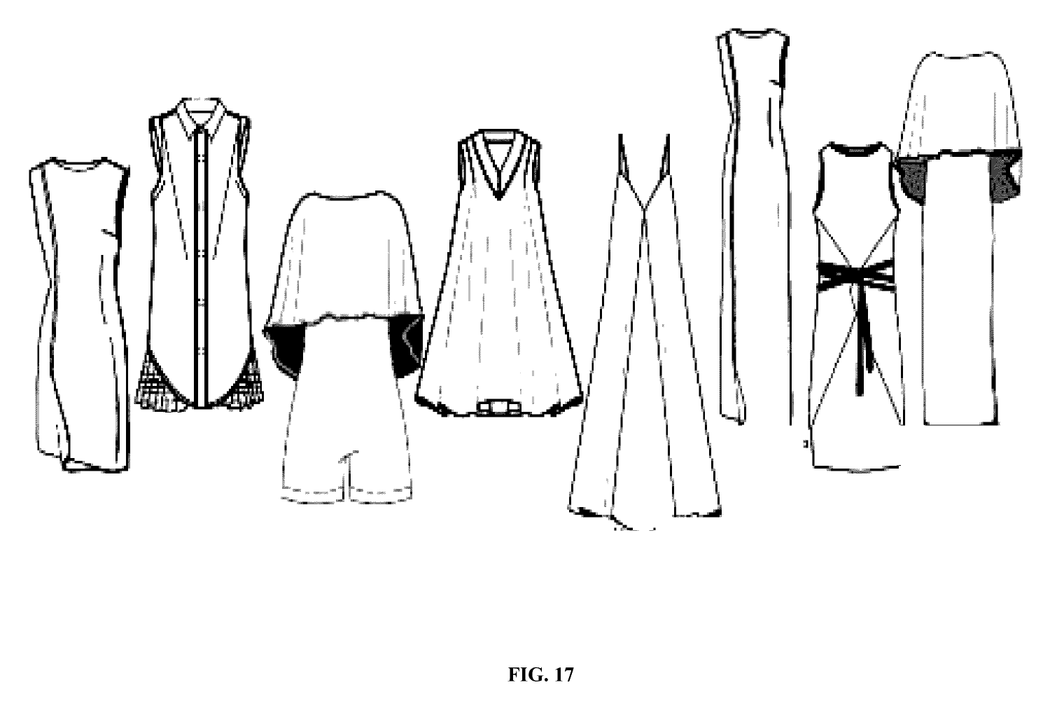

In some embodiments, multiple pieces of long-term cooling material can be wrapped or folded within an article of manufacture such that cooling is enhanced. For example, as shown in the leftmost dress of FIG. 16, a wrap portion composed of long-term cooling material can be draped around the mid-section of the dress while the portion under the draped section can also be composed of long-term cooling material such that enhanced cooling is provided around the mid-section of the dress.

While single or multiple layers of long-term cooling material can compose particular articles of manufacture, in yet other embodiments, long-term cooling material can be strategically placed at one or more portions of an article of manufacture. In some embodiments, for example, the long-term cooling material can be an inner layer or intermediate layer of cooling material strategically located at body areas. For example, the long-term cooling material can be strategically located at body areas having a higher likelihood of overheating or bringing relief through cooling.

Accordingly, in some embodiments, the long-term cooling material is employed with one or more other materials to form the apparel, bedding and/or shoes. For example, in some embodiments, the long-term cooling material portion of the article of manufacture is strategically placed so as to provide cooling at particular locations of the body. In one embodiment, an article of manufacture can be composed of long-term cooling material disposed at an inner layer of the article of manufacture (where the inner layer is intended to be placed immediately adjacent the skin of the wearer/user during wearing/use) while other material (e.g., non-cooling material) is provided as an outer layer of the article of manufacture.

In some embodiments, in lieu of providing the long-term cooling material as an entire layer of the article of manufacture, the long-term cooling material can be strategically limited to locations of the article of manufacture. For example, in some embodiments, the long-term cooling material can be strategically placed at the area of a garment, bedding or shoes corresponding to arm pits or crotch areas in exercise or athletic apparel, neck or back areas or the sole or upper portion of a foot) for cooling the body area corresponding to the locations of the long-term cooling material. In this embodiment, when worn or used, the article of manufacture can be manufactured with the long-term cooling material positioned such that the long-term cooling material rests substantially in one or more areas prone to body overheating.

FIGS. 19-23 illustrate various examples. Turning first to FIG. 19, illustrated are perspective views of examples of a cowl neck blouse and a multi-layer blouse, each composed of strategically placed long-term cooling material and non-cooling material in accordance with one or more embodiments described herein. Repetitive description of like elements employed in other embodiments described herein is omitted for sake of brevity. As shown in FIG. 19, the long-term cooling material can be provided around the neck region of the cowl neck blouse while non-cooling material can be provided as material to compose the remainder of the blouse. As another example, non-cooling material can be provided as an outer layer of the rightmost blouse while long-term cooling material can be provided as an inner layer under the outer layer and near the skin of the wearer. The bedding of FIG. 24 is yet another example. FIG. 24 illustrates a perspective view of an example of a duvet cover having a top layer composed of non-cooling material and a bottom layer (e.g., the layer immediately adjacent a user of the duvet cover lying under the cover) composed of long-term cooling material in accordance with one or more embodiments described herein.

FIG. 20 illustrates perspective, side and top views of examples of a jacket, shoes, boots and a shirt, each composed of strategically placed long-term cooling material and non-cooling material in accordance with one or more embodiments described herein. Repetitive description of like elements employed in other embodiments described herein is omitted for sake of brevity. As shown in FIG. 120, various portions of shoes (e.g., sole) can be cooling while various portions (e.g., upper) can be either composed of long-term cooling material. In another shoe, the inner lining and the sole can be composed of or have placed on long-term cooling material while the outer upper lining can be non-cooling. Any number of combinations are possible.

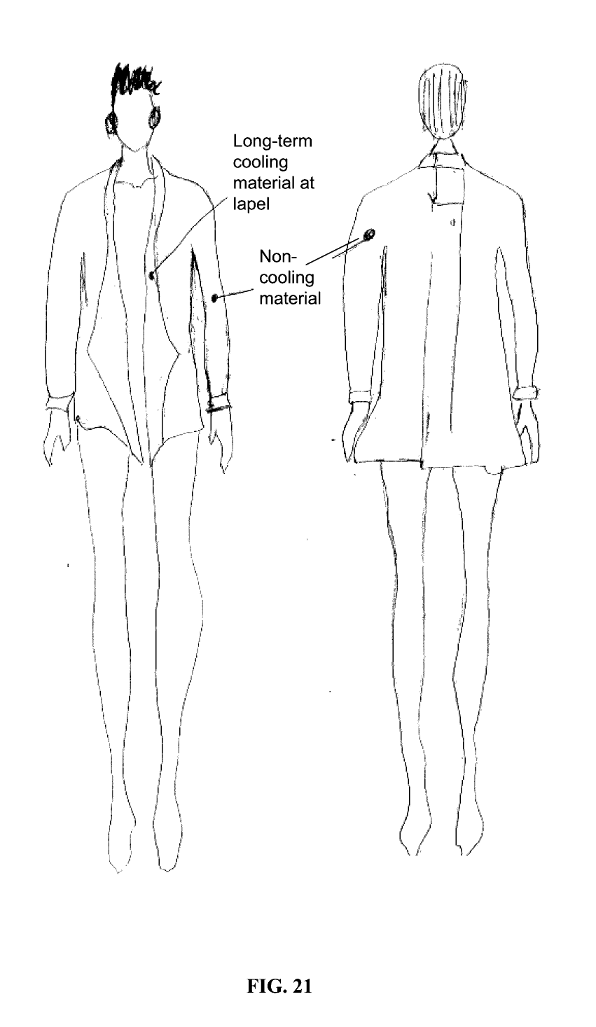

As also shown in FIG. 20, long-term cooling material can be provided at the upper yoke and trim of the tank top while non-cooling material can be provided in one or more remaining portions of the tank top. As also shown in FIG. 20, one or more portions of the jacket can be composed of or include long-term cooling material. For example, as also shown in FIG. 21, the lapel and/or inner lining of the jacket can be composed of long-term cooling material. FIG. 21 illustrates perspective views of an examples of a jacket having a lapel including and/or composed of strategically placed long-term cooling material and non-cooling material in accordance with one or more embodiments described herein.

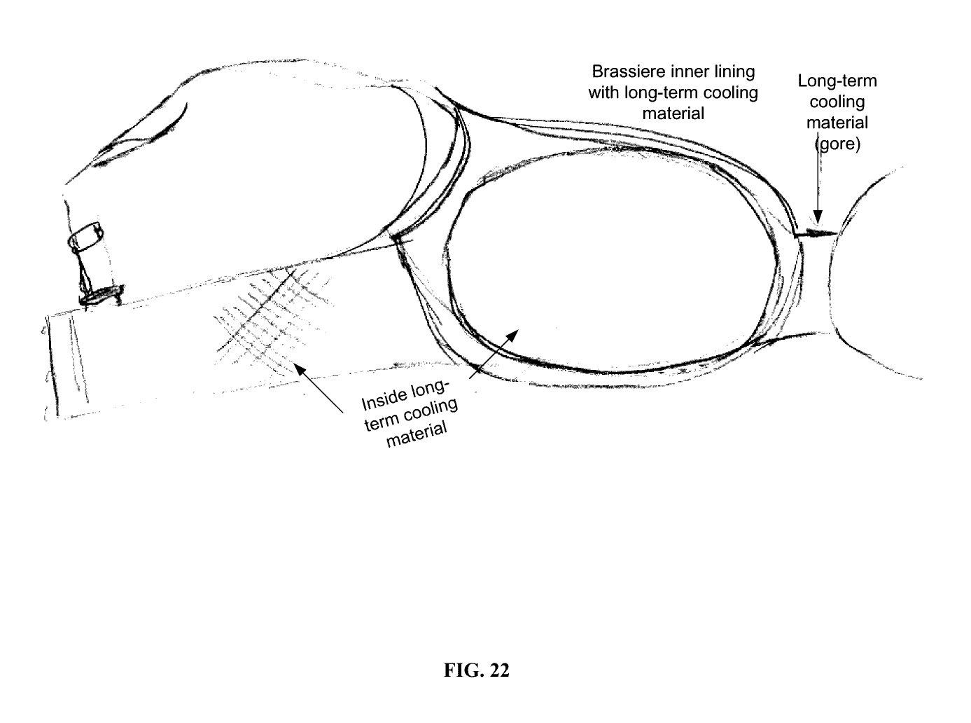

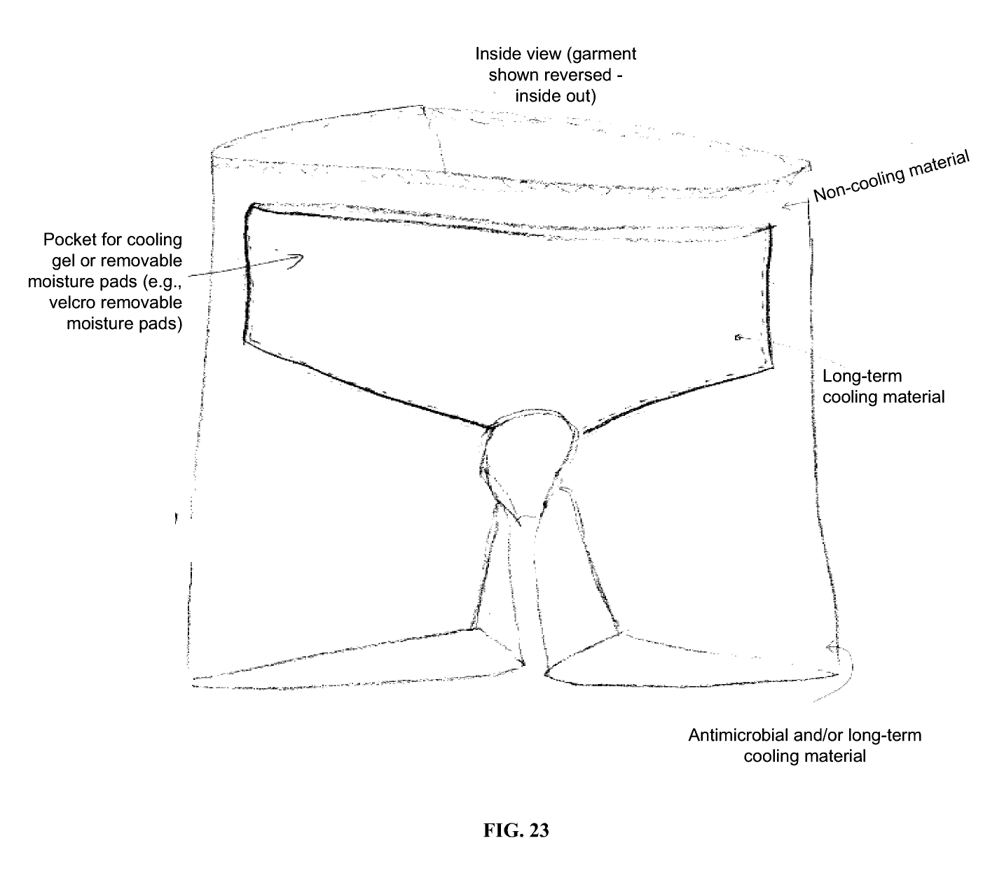

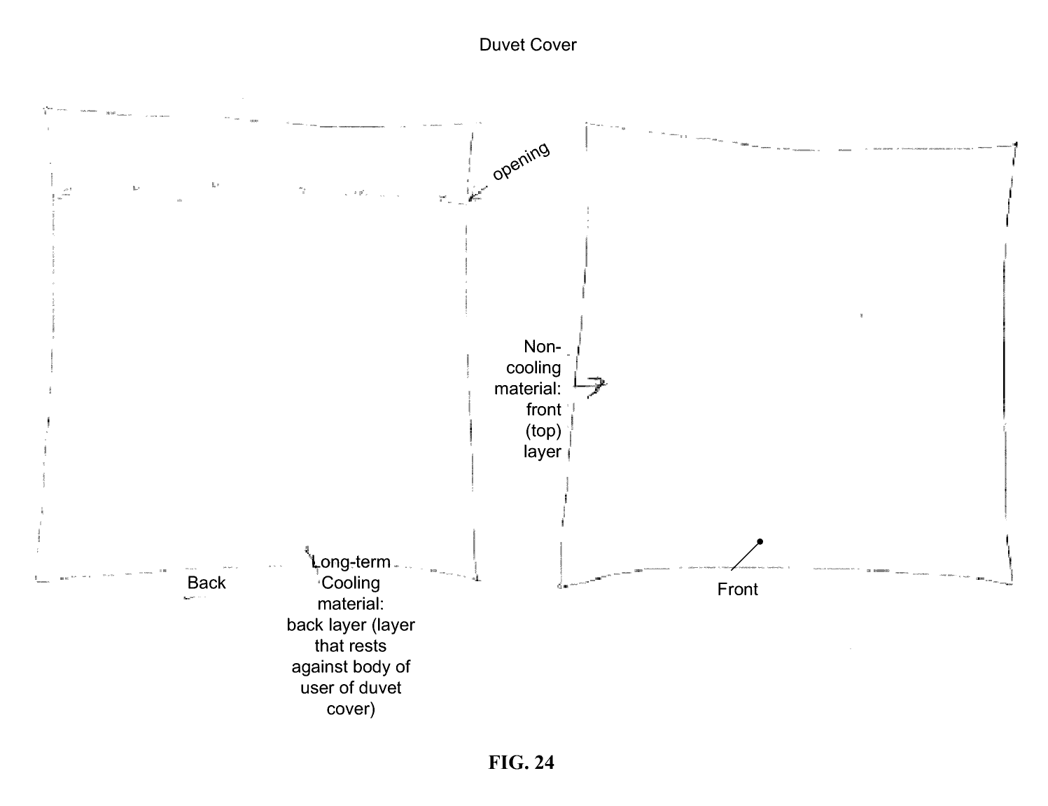

FIG. 22 illustrates a perspective view of an example of a brassiere having an inner lining including and/or composed of long-term cooling material and cooling gore provided at the mid-section of the brassiere in accordance with one or more embodiments described herein. FIG. 23 illustrates a perspective view of an example of an undergarment having a pocket for cooling gel or removable moisture pads, anti-microbial and/or long-term cooling material and non-cooling material strategically positioned within the undergarment in accordance with one or more embodiments described herein.

In some embodiments, the article of manufacture can include the long-term cooling material provided as an intermediate layer between two or more layers of non-cooling material so as to not be easily viewed by the wearing or passers-by of wearers wearing/using the article of manufacture. The intermediate layer can be permanently affixed (e.g., sewn or knitted into the article of manufacture) in some embodiments.

In some embodiments, the article of manufacture can include long-term cooling material temporarily or permanently affixed to another layer (e.g., outer layer) of material to allow the long-term cooling material to be removed depending on the preferences of the wearer/user, for multi-seasonal use or the like. Any type of apparatus can be employed to couple the inner layer and outer layer (or the inner layer and an intermediate layer) to one another including, but not limited to, zippers, buttons, Velcro, stitching or any suitable means for temporarily or permanently affixing/adhering the inner layer to the outer layer.

In some embodiments, an article of manufacture can include or have long-term cooling material strategically located in conjunction with one or more other materials. In some embodiments, an article of manufacture can employ a long-term cooling material formed as a structure (e.g., formed as a structure within shoes and/or boots). With regard to shoes and/or boots, articles of manufacture can include the long-term cooling material in conjunction with other materials in a number of different ways.

In various embodiments, the long-term cooling material can be strategically placed at locations likely to overheat (e.g., shoe sole, shoe upper) as shown at FIG. 20. For example, in a lace up shoe, one or more portions of the upper of the shoe and/or the entire upper of the shoe can be provided as the long-term cooling material in a single layer knitting. As another example, a shoe upper can be composed of a single layer of long-term cooling material placed alongside a non-cooling material. For instance, a leather fabric of a shoe can be stitched against the long-term cooling material (which can be an inner lining of the shoe). In another embodiment, the long-term cooling material can be a second layer lined against a first, outer layer of a different material. The sole insert inside the shoe can also be covered in the long-term cooling material in some embodiments.

In some embodiments of shoes and/or boots, the full sole of the shoe and/or boot can be composed of the long-term cooling material, or the long-term cooling material can be provided within the shoe in the form of an arch support. In some embodiments, to facilitate foot support, comfort and/or cooling, the shoe and/or boot can include the long-term cooling material located in the majority of the upper.

In some embodiments, an article of manufacture can have different deniers of the long-term cooling material for comfort and/or durability. Depending on the needs of the particular type of the article of manufacture, in various embodiments, different stitching can be employed. For example, an article of manufacture can include long-term cooling material in varying deniers. The finer the denier, the more fragile the article of manufacture (or material from which the article of manufacture is composed) while the higher the denier, the more durable the article of manufacture (or material from which the article of manufacture is composed). For instance, in a wrap or scarf, a 20 denier can be employed and the garment will be very fine and ultra soft. In a shoe, however, a 240 denier can be employed to provide durability. In other embodiments, the long-term cooling material can be knit with a variety of spandex deniers, including, but not limited to, 20 denier, 40 denier, 70 denier, and above. In some embodiments, a single article of manufacture can include different deniers of long-term cooling material at different locations.

In some embodiments, although not shown, one or more articles of manufacture such as a shirt can have a first mesh portion and a second satin (which can be or include the long-term cooling material) at the armhole portion for cooling in accordance with one or more embodiments described herein.

In these embodiments, special machines can be utilized to provide particular deniers. For example, articles of manufacture can be constructed via the cut and sew method or knit on a circular or sweater, or raschel machine can be provided in different deniers.

In some embodiments, the articles of manufacture can include one or more coatings on one or more portions of the article of manufacture. By way of example, but not limitation, cooling softeners (which can add additional ultra cooling properties) can be provided as a coating on the long-term cooling material.

In some embodiments, resin coatings can be strategically added to the material (or to particular locations of the material corresponding to areas in which the article of manufacture, when in use, can benefit from having extra support and/or control). Bonding and/or flocking can also be employed with any article of manufacture to provide additional support and/or control. In some embodiments, coatings such as bonding, resin, or flocking can be used as hems in the article of manufactures as well. For example, bonding, flocking and/or resin can also be applied around the waist of a legging, pant, short, or mid-thigh short article of manufacture; the wing of a bra; or wherever additional support is needed.

In various embodiments, coatings that can be employed with the article of manufactures include, but are not limited to, antimicrobial, skin softening, and/or cosmetic coatings. These coatings can be applied during the dye process and may wash out eventually. As such, embodiments of articles of manufacture described herein can include the long-term cooling material in conjunction with antimicrobial and/or skin softening properties.

Accordingly, embodiments of the articles of manufacture can include coatings such as resin, bonding material, flocking, self fabric or other bonded onto long-term cooling material, liquid spandex, antimicrobial, quick dry, skin firming, softening, silicon softening finish of non-silicone softeners. Additional cooling finishes can also be applied to the long-term cooling material. By way of example, but not limitation, the cooling finish can include, but is not limited to, Xylitol and/or menthol.

Certain types of coatings (e.g., coatings such as softeners, antimicrobials, and cosmetic coatings) can be applied over the entirety of the long-term cooling material. For example, the coatings can be applied during the dye bath of the long-term cooling material and/or any other fabric included as part of the article of manufacture. Other types of coatings (e.g., coatings such as bonding, flocking, or resin) can be applied at hems. In some embodiments, the location at which the upper of a shoe article of manufacture is attached to the sole and/or the apertures in the shoe through which the laces are provided can also include bonding, flocking and/or resin.

FIGS. 25-27 illustrate perspective views of cooling pouches having one or more portions composed of long-term cooling material in accordance with one or more embodiments described herein. In some embodiments, article of manufactures can have a sewn-in pocket or a knit-in pocket, which holds a cold pack or cooling pouch (see FIG. 25). The pocket can also be provided for removable moisture pads or the like.

In some embodiments, an article of manufacture can include the apparel, shoe and/or bedding including or composed of cooling material in combination with an insulated pouch or case to house the apparel, shoe and/or bedding. For example, a bandana article of manufacture composed of the long-term cooling material can be provided inside an insulated pouch that the wearer can maintain in the refrigerator/freezer/other cooling area for a defined amount of time (e.g., overnight). The pouch (or, in some embodiments, the pouch and apparel and/or shoe) can be removed from the cooling area and stored inside of a handbag, purse, gym bag, brief case, backpack, or luggage for use throughout the day or evening. As such, the apparel and/or shoe can be kept super-cooled and clean in the cooling area inside the insulated pouch when not in use.

An example of a pouch that can be employed is shown in the drawings (see FIGS. 25-27). In the embodiment shown, the pouch, case, envelope, or bag can close with a zipper, drawstring, button, hook and eye, or Velcro. The case is made of two or more layers. The outer layer is decorative fabric and can be composed of cotton, silk, nylon, polyester, rayon, viscose, acrylic, modal, rayon, linen, hemp and/or bamboo. The second layer can be an intermediate layer that interfaces with the long-term cooling material. The second layer can be composed of cotton, nylon, polyester, rayon, viscose, and/or acrylic. In some embodiments, the second layer or third layer is a thermal layer that can be composed of a plastic film and/or cooling gel. If the pouch has a fourth layer, the fourth layer can be a liner that can comprise a layer made of plastic, polyester, nylon, rayon, viscose, or acrylic. In some embodiments, the second, third and/or fourth layer can be or include the long-term cooling material instead of or in addition to the materials noted.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A cooling material, comprising:
a yarn having a defined denier of less than or equal to approximately 70 denier and a defined yarn count; and
at least one of a cooling mineral compound powder, a cooling mineral core or nanosilver, wherein the at least one of the cooling mineral compound powder, the cooling mineral core or nanosilver is disposed on or in the yarn, and wherein the cooling material is a material knit on a 28 gauge or greater knitting machine.

2. The cooling material of claim 1, wherein the defined yarn count is greater than or equal to approximately 36 rows per inch.

3. The cooling material of claim 1, wherein the yarn comprises Nylon 6 or polyamide.

4. The cooling material of claim 1, wherein the yarn comprises at least one of polyester, polyporopylene, polyacrylonitrile or rayon.

5. The cooling material of claim 1, wherein the cooling material is a material knit on a knitting machine having a gauge approximately equal to or greater than a 36 gauge knitting machine and approximately equal to or less than a 50 gauge knitting machine.

6-8. (canceled)

9. The cooling material of claim 1, wherein the cooling material is configured to lower a skin temperature of a wearer or user of the cooling material based on placement of the cooling material adjacent the skin of the wearer or user.

10. The cooling material of claim 1, wherein the cooling material is formed as an item of apparel or bedding.

11. An article of manufacture, comprising:
a cooling fabric comprising yarn having a denier of less than or equal to approximately 70 denier and a yarn count greater than or equal to approximately 36 rows per inch, wherein at least one of a cooling mineral compound powder or a cooling mineral core is disposed on or in the yarn, and wherein the cooling fabric results from the yarn being knitted on a 28 gauge or greater knitting machine.

12. The article of manufacture of claim 11, wherein the cooling fabric is incorporated into at least a portion of a body of a shoe.

13. The article of manufacture of claim 11, wherein the article of manufacture comprises at least one of a wrap, a bandana or a scarf.

14. The article of manufacture of claim 11, wherein the article of manufacture comprises at least one of bedding, animal apparel or baby apparel.

15. The article of manufacture of claim 11, wherein the article of manufacture comprises a pouch.

16. A method of manufacture, comprising:
receiving, by a circular knitting machine, yarn having a composition disposed to provide cooling;
knitting, by the circular knitting machine, the yarn; and
outputting, from the circular knitting machine, an article of manufacture as a garment in a form of a tube, wherein the outputting is resultant from the knitting.

17. The method of manufacture of claim 16, wherein the circular knitting machine is at least one of 28 gauge, 36 gauge or 40 gauge.

18. The method of manufacture of claim 16, wherein the yarn has at least one of nanosilver or a mineral cooling powder disposed on or within the yarn.

19. The method of manufacture of claim 16, wherein the yarn is composed of Nylon 6 or polyamide.

20. The method of manufacture of claim 16, wherein the garment comprises at least one of a dress, a pair of culottes or a blouse.

21. A cooling fabric, comprising:
a yarn having a defined denier of less than or equal to approximately 240 denier and a defined yarn count; and
at least one of a cooling mineral compound powder, a cooling mineral core or nanosilver, wherein the at least one of the cooling mineral compound powder, the cooling mineral core or nanosilver is at least one of combined with, knit with or extruded into the yarn, and wherein the cooling fabric comprises a fabric knit on a 28 gauge or greater knitting machine.

22. The cooling fabric of claim 21, wherein the defined yarn count comprises greater than 36 rows per inch.

23. The cooling fabric of claim 21, wherein the cooling fabric comprises at least one of knit fabric or a woven fabric.

24. The cooling fabric of claim 21, wherein the knitting machine comprises a warp knitting machine or a weft knitting machine.
